(19) United States
(12) Patent Application Publication
(10) Pub. No.: US 2019/0266200 A1
(43) Pub. Date: Aug. 29, 2019

(54) SYSTEMS AND METHODS FOR REDIRECTING TO TRACK USER IDENTIFIERS ACROSS DIFFERENT WEBSITES

(71) Applicant: AirDXP, Inc., New York, NY (US)

(72) Inventor: Steven Francolla, Brooklyn, NY (US)

(21) Appl. No.: 16/284,894

(22) Filed: Feb. 25, 2019

Related U.S. Application Data
(60) Provisional application No. 62/635,259, filed on Feb. 26, 2018.
(60) Provisional application No. 62/754,990, filed on Nov. 2, 2018.

(51) Int. Cl. G06F 16/955; H04L 29/08; H04L 29/12

(52) U.S. Cl. CPC G06F 16/955; H04L 61/1511; H04L 67/146; H04L 67/22

(57) ABSTRACT

Described herein are systems and methods for redirecting to track user identifiers across web sessions and websites. A web browser may receive a first webpage requested by a user of the client. The first webpage may be referenced by a first address including a domain name of the website host and may include a linkage script. The linkage script may be provided by a tracking service and may specify retrieval of a second webpage of the website host. The web browser may determine whether a user identifier of the tracking service is associated with a cookie of the website host. The web browser may identify a second address including at least a portion of the domain name. The web browser may transmit a request for the second webpage of the website host including the second address. The web browser may receive the second webpage for display.

### CROSS REFERENCES TO RELATED APPLICATIONS

The present application claims the benefit of priority under 35 U.S.C. § 119(e) to U.S. Provisional Application No. 62/635,259, titled “SYSTEMS AND METHODS FOR MEDIA PARTNER INTEGRATION AND NEUTRAL ID USAGE,” filed Feb. 26, 2018, and to U.S.

Provisional Application No. 62/754,990, titled “SYSTEMS AND METHODS FOR CROSS-SITE VIA NATIVE INTERSTITIAL,” filed Nov. 2, 2018, both of which are incorporated herein in their entireties.

### TECHNICAL FIELD

The present application relates generally to systems and methods for tracking web activity, including but not limited to systems and methods for redirecting to track user identifiers across web sessions and websites.

### BACKGROUND

Users' activities on the web can provide insight to the users' interests and behavior. Increased web traffic, aggressive browser cookie restriction policies, and/or website owner data protection concerns can pose challenges to collection of data from online activities.

### SUMMARY

Described herein are systems and methods for redirecting to track user identifiers across web sessions and websites. A user operating a client device may use a web browser to visit a webpage of a website. The webpage may have content provided by the website host (e.g., the publisher) and third-party content provided by supplemental content hosts. The content provided by the website host may be associated with an address containing a domain name of the website. The third-party content provided by the supplemental content host may be associated with a different address containing a domain name of the supplemental content host. The third-party content may be in one of the content objects of the webpage. The supplemental content hosts may track activities of the user on different web sessions and various websites by using a tracking cookie. The tracking cookie (also sometimes referred herein as a third-party cookie) may be stored onto the client when the user interacts with the supplemental content on the webpage. The tracking cookie may include the domain name of the supplemental content host, as opposed to the domain name of the website host that provided the webpage. Using the tracking cookie, the supplemental content host may correlate activities of user across different web sessions and websites, and may provide analyses of the correlations to website hosts and attribute activities to the webpages of the website host.

Certain web browsers, however, may restrict cross-site tracking using cookies with domain names different from the domain name of the website hosting the currently loaded webpage. Such web browser may scan the generated third-party cookie to determine whether the domain name matches with the domain name of the website, and block the third-party cookie from storage onto the client when the domain names mismatch. This restriction may prevent the supplemental content hosts from tracking activity across different web sessions and webpages. Without the ability to track activities using the tracking cookie, the supplemental content hosts may not be able to correlate activities across different websites and provide analyses of the correlation to website hosts. Although website hosts are not prevented from tracking users on the webpages of the website, the prohibition against third-party cookies may affect website hosts from attribution of the user activities to the webpages of the website host. The lack of attribution may impact the ability of the website host to evaluate and determine user activity on the webpages (e.g., assessment of the effectiveness of webpage content and design in interaction rates).

To address the technical challenges in tracking users across web sessions and different websites with such web browsers, a linkage script may be inserted into the webpage to redirect the web browser to facilitate the tracking of user activity. The linkage script may be a computer-readable instructions provided by a tracking service. The content object may be provided by the website host or the supplemental content host, and may be a link to another webpage of the website host. The tracking service that provided the linkage script may maintain a database of user identifiers associated with users across various web session and websites. The user identifiers for a single user may include: a service user identifier (sometimes referred to as a master identifier) for the user across different domains, a website user identifier (sometimes referred to as a local identifier) for the user for a particular website host, and a supplemental content user identifier (sometimes referred to as a global identifier) for the user for a particular supplemental content host. With the visiting of the website, the web browser may store a cookie for the website onto the client.

Upon receipt of the webpage, the web browser may request for the linkage script. With the request for the linkage script, the tracking service may determine whether the client has a service user identifier associated with the cookie for the web site host. To that end, the tracking service may determine whether cookie is associated with any of the service user identifiers on the database maintained by the tracking service. Based on the determination, the tracking service may select and provide the linkage script to the web browser running on the client. The web browser may generate a request for the webpage linked via the content object based on the determination of whether the user is associated with any of the service identifiers. If the cookie is determined to be associated with one of the service identifiers, the web browser may identify an address for the requested webpage to include the full domain name of the website host (e.g., “www.example.com”). The web browser may generate and transmit the request using the identified address to fetch the webpage from the website host. The web browser may subsequently receive the webpage of the website host referenced by the full domain name and the pathname particular to the webpage (e.g., “www.example.com/page_ex1.html”).

On the other hand, if the cookie is determined to be not associated with any of the service identifiers, the web browser may identify an address for the requested webpage to include a portion of the domain name of the website host and a defined string for the tracking service (e.g., “www.example.trk.sh”). The web browser may also generate a website user identifier for the user particular to the website host for storage as the cookie on the client. Because the domain of the cookie is set to the domain name of the website host, the web browser may store the cookie onto the client. In addition, the web browser may generate and transmit the request using the identified address with the defined string to fetch the requested webpage (e.g., “www.example.trk.sh/page_ex1.html”). As the address includes the string for the tracking service, the request may be routed by a domain name system (DNS) server to the tracking service. The tracking service in turn may store the website user identifier generated by the client, and may return the webpage of the website host to the client. The web browser may subsequently receive the webpage of the website host referenced by a portion of the domain name, the defined string for the tracking service, and the pathname particular to the webpage (e.g., “www.example.trk.sh/page_ex1.html”).

The received webpage may have another content object. The content object may be a link to another webpage of the website host. Upon receipt of the webpage, the web browser may request for the linkage script to tracking service. With the website user identifier stored on the client as the cookie, the tracking service may determine whether the website user identifier is associated with any of the service user identifiers on the database maintained by the tracking service. Based on the determination, the tracking service may select and provide the linkage script to the web browser running on the client. If the website user identifier is determined to not be associated with any of the service user identifiers, the web browser may generate a service user identifier for the user for storage on a cookie on the client. The service user identifier may then be linked or associated with the website user identifier generated for the same user. The association of the website user identifier with the service user identifier may be stored onto the database of the tracking service. Conversely, if the website user identifier is determined to be associated with one of the service user identifiers, the web browser may skip the generation of the service user identifier. In any event, the web browser may identify an address for the requested webpage to include the full domain name of the website host (“www.example.com”). The web browser may generate and transmit the request using the identified address to fetch the webpage from the website host. The web browser may subsequently receive the webpage of the website host referenced by the full domain name and the pathname particular to the webpage (e.g., “www.example.com/page_ex2.html”).

By directing the web browser to another domain name as specified by the linkage script, the web browser may associate the service user identifier for the tracking service with the cookie of the website host. The tracking service may also store the service user identifier and the website user identifier upon visiting of the webpage referenced using the defined string for the tracking service. The linking of the service user identifier with multiple website user identifiers may facilitate the tracking of the user activity across multiple websites, without the use of third-party cookies banned on certain web browsers.

At least one aspect of this disclosure is directed to a method of redirecting to track user identifiers across web sessions and websites. A web browser executing on a client having one or more processors may receive, from a website host via a network, a first webpage requested by a user of the client. The first webpage may be referenced by a first address including a domain name corresponding to the website host. The first webpage may include a linkage script and a content object to link to a second webpage of the website host. The linkage script may be provided by a tracking service and may specify retrieval of a second webpage. Whether a user identifier of the tracking service is associated with a cookie of the website host may be determined. The web browser may identify a second address referencing the second webpage as specified by the linkage script based on determining whether the user identifier of the tracking service is associated with the cookie of the website host. The second address may include at least a portion of the domain name of the website host. The web browser may transmit, via the network responsive to an interaction with the content object, a request for the second webpage of the website host. The request may include the second address referencing the second webpage. The web browser may receive, via the network, the second webpage referenced by the second address for display on the client

In some embodiments, determining whether the user identifier is associated with the cookie further comprises determining that the user identifier is associated with the cookie. In some embodiments, identifying the second address may include selecting the second address including an entirety of the domain name of the website host in accordance with the linkage script to direct the request to the website host, responsive to determining that the user identifier is associated with the cookie.

In some embodiments, determining whether the user identifier is associated with the cookie further comprises determining that the user identifier is not associated with the cookie. In some embodiments, the web browser may generate the user identifier for the user based on the domain name responsive to determining that the user identifier is not associated with the cookie. In some embodiments, identifying the second address may include selecting the second address including a portion of the domain name of the website host and a defined string for the tracking service to direct the request to the tracking service in accordance with the linkage script. In some embodiments, transmitting the request may include transmitting the request for the second webpage. The request may include the user identifier to store the user identifier for the user.

In some embodiments, determining whether the user identifier is associated with the cookie further comprises determining that the user identifier is not associated with the cookie. In some embodiments, the web browser may generate the user identifier for the user based on the domain name responsive to determining that the user identifier is not associated with the cookie. In some embodiments, identifying the second address may include selecting the second address including a hostname and a query. The hostname of the second address may include a portion of the domain name of the web site host and a defined string for the tracking service to direct the request to the tracking service. The query may include the user identifier.

In some embodiments, determining whether the user is associated with the user identifier may include accessing a database storing a plurality of user identifiers maintained by the tracking service to determine whether the user identifier corresponds to any of the plurality of user identifiers. In some embodiments, transmitting the request may include transmitting the request via the network to a domain name system (DNS) server. The DNS server may be configured to route the request to the tracking service responsive to determining that the second address included in the request includes the portion of the domain name of the website host and a defined string for the tracking service. In some embodiments, receiving the first webpage may include receiving the first webpage including the linkage script. The content object may correspond to a hyperlink to the second webpage of the website host. The hyperlink may be modified in accordance with the linkage script.

In some embodiments, receiving the second webpage may include receiving the second webpage referenced by the second address including a portion of the domain name of the website host and a defined string for the tracking service. The second webpage may include a second linkage script. In some embodiments, the web browser may determine whether the user identifier is associated with the cookie. In some embodiments, the web browser may generate the master identifier for the user responsive to determining whether the user identifier is associated with the cookie in accordance with the second linkage script.

In some embodiments, receiving the second webpage may include receiving the second webpage referenced by the second address including a portion of the domain name of the website host and a defined string for the tracking service. The second webpage may include a second linkage script. In some embodiments, whether the user identifier is not linked with a master user identifier maintained by the tracking service for the user may be determined. In some embodiments, the web browser may associate the user identifier with the master identifier responsive to determining that the user identifier is not linked with the master user identifier.

In some embodiments, receiving the second webpage may include receiving the second webpage referenced by the second address including a portion of the domain name of the website host and a defined string for the tracking service. The second webpage may include a second linkage script and a second content object. The second content object may have a third address referencing a third webpage of the website host. In some embodiments, the web browser may identify the third address referencing the third webpage as specified by the second linkage script responsive to determining that the user identifier is linked with a master user identifier. The third address may include the domain name of the website host and lack any defined string for the tracking service. In some embodiments, the web browser may transmit, via the network, a request for the third webpage of the website host. The request may include the third address referencing the second webpage. In some embodiments, the web browser may receive, via the network, the third webpage referenced by the third address for display on the client.

At least one aspect of this disclosure is directed to a system for redirecting to track user identifiers across web sessions and websites. The system may include a web browser executable on a client having one or more processors. The web browser may receive, from a website host via a network, a first webpage requested by a user of the client, the first webpage referenced by a first address including a domain name corresponding to the website host. The first webpage may include a linkage script and a content object to link to a second webpage of the website host. The linkage script may be provided by a tracking service and specify retrieval of the second webpage. The web browser may identify a second address referencing the second webpage as specified by the linkage script based on determining whether the user identifier of the tracking service is associated with the cookie of the website host. The second address may include at least a portion of the domain name of the website host. The web browser may transmit, via the network responsive to an interaction with the content object, a request for the second webpage of the website host. The request may include the second address referencing the second webpage. The web browser may receive, via the network, the second webpage referenced by the second address for display on the client.

In some embodiments, the web browser may select the second address including an entirety of the domain name of the website host in accordance with the linkage script to direct the request to the website host, responsive to determining that the user is associated with the user identifier.

In some embodiments, the web browser may generate the user identifier for the user based on the domain name responsive to determining that the user identifier is not associated with the cookie. In some embodiments, the web browser may select the second address including a portion of the domain name of the website host and a defined string for the tracking service to direct the request to the tracking service in accordance with the linkage script. In some embodiments, the web browser may transmit the request for the second webpage. The request may include the user identifier to store the user identifier for the user.

some embodiments, the web browser may generate the user identifier for the user based on the domain name responsive to determining that the user identifier is not associated with the cookie. In some embodiments, the web browser may select the second address including a hostname and a query. The hostname of the second address may include a portion of the domain name of the web site host and a defined string for the tracking service to direct the request to the tracking service. The query may include the user identifier.

In some embodiments, the tracking service may access a database storing a plurality of user identifiers maintained by the tracking service to determine whether the user identifier corresponds to any of the plurality of user identifiers. In some embodiments, the web browser may transmit the request via the network to a domain name system (DNS) server. The DNS server may be configured to route the request to the tracking service responsive to determining that the second address included in the request includes the portion of the domain name of the website host and a defined string for the tracking service. In some embodiments, the content object may correspond to a hyperlink to the second webpage of the website host. The hyperlink may be modified in accordance with the linkage script.

In some embodiments, the web browser may receive the second webpage referenced by the second address including a portion of the domain name of the website host and a defined string for the tracking service. The second webpage may include a second linkage script. In some embodiments, the web browser may generate the master identifier for the user responsive to determining whether the user identifier is associated with the cookie in accordance with the second linkage script.

In some embodiments, the web browser may receive the second webpage referenced by the second address including a portion of the domain name of the website host and a defined string for the tracking service. The second webpage may include a second linkage object. In some embodiments, the web browser may associate the user identifier with the master identifier responsive to determining that the user identifier is not linked with the master user identifier.

In some embodiments, the web browser may receive the second webpage referenced by the second address including a portion of the domain name of the website host and a defined string for the tracking service. The second webpage may include a second linkage script and a second content object. The second content object may have a third address referencing a third webpage of the website host. In some embodiments, the web browser may identify the third address referencing the third webpage as specified by the second linkage script responsive to determining that the user identifier is linked with a master user identifier. The third address may include the domain name of the website host and lack any defined string for the tracking service. In some embodiments, the web browser may transmit, via the network, a request for the third webpage of the website host. The request may include the third address referencing the second webpage. In some embodiments, the web browser may receive, via the network, the third webpage referenced by the third address for display on the client.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

It should be understood that the drawings primarily are for illustrative purposes and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

FIG. 1A is a block diagram depicting an embodiment of a network environment comprising client devices in communication with server devices;

FIG. 1B is a block diagram depicting a cloud computing environment comprising client devices in communication with a cloud service provider;

FIGS. 1C and 1D are block diagrams depicting embodiments of computing devices useful in connection with the methods and systems described herein;

FIG. 2A is an example representation of services provided by an NID platform;

FIGS. 2B and 2C show example scenarios in which a cookie may expire after certain time periods unless the cookie is refreshed by the NID platform;

FIG. 2D depicts an example implementation of the NID platform in relation to a media partner;

FIGS. 2E and 2F depict example embodiments of an ID refresh system;

FIG. 2G depicts an example embodiment of an ID request system;

FIG. 2H is a flow diagram depicting an example embodiment of a method for tracking user identifiers across web sites;

FIG. 3A is a block diagram depicting an example system for redirecting to track user identifiers across web sessions and websites;

FIG. 3B depicts a sequence diagram depicting a process for redirecting to track user identifiers across web sessions and websites;

FIGS. 3C and 3D each is a sequence diagram depicting a process for redirecting to track user identifiers across web sessions and websites;

FIG. 3E is a block diagram of a database for maintaining user identifiers tracked across web sessions and websites;

FIG. 3F depicts a list diagram depicting a process for site integration into webpages for redirecting; and

FIG. 4 is a flow diagram deciding an example method of redirecting to track user identifiers across web sessions and websites.

The features and advantages of the concepts disclosed herein will become more apparent from the detailed description set forth below when taken in conjunction with the drawings.

### DETAILED DESCRIPTION

Following below are more detailed descriptions of various concepts related to, and embodiments of, inventive systems and methods for classifying content to prevent data breach or exfiltration. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Section A describes a network environment and computing environment which may be useful for practicing various computing related embodiments described herein.

Section B describes systems and methods for tracking user identifiers across web sessions and websites.

Section C describes systems and methods for redirecting to track user identifiers across web sessions and websites.

It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

### A. Computing and Network Environment

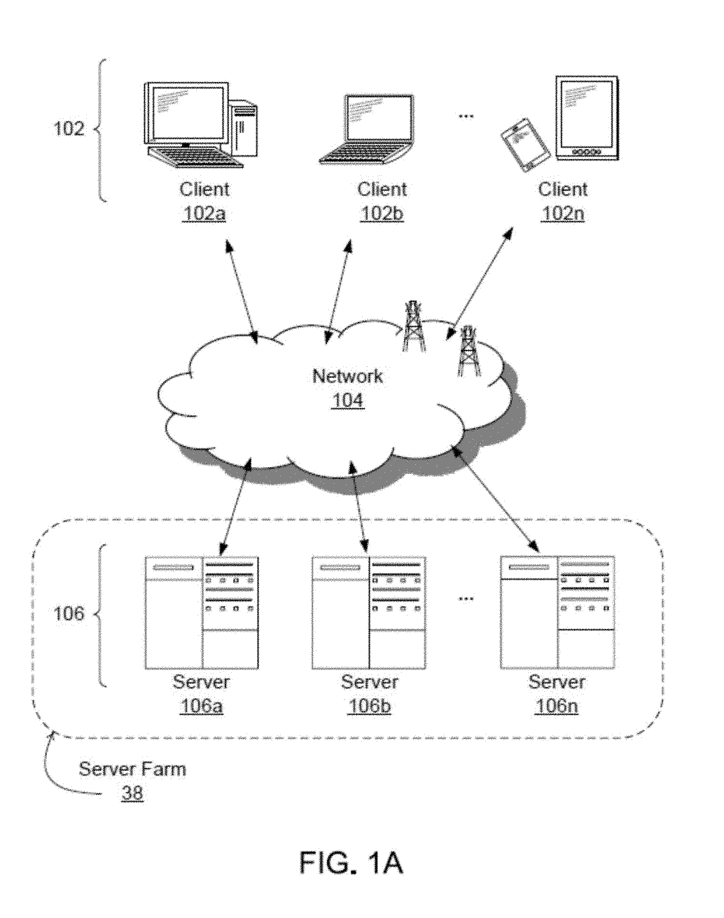

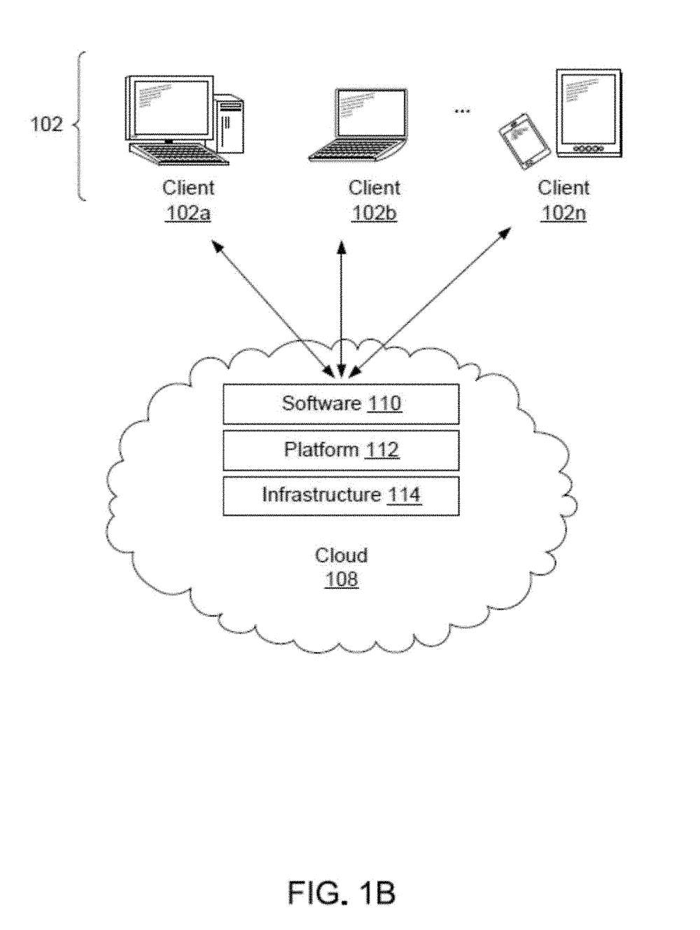

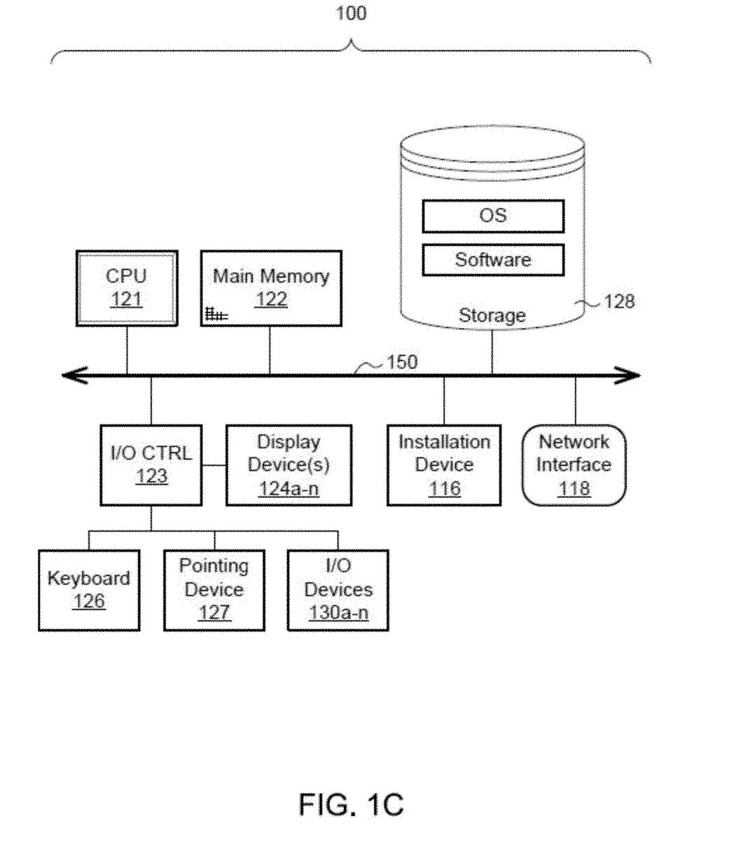

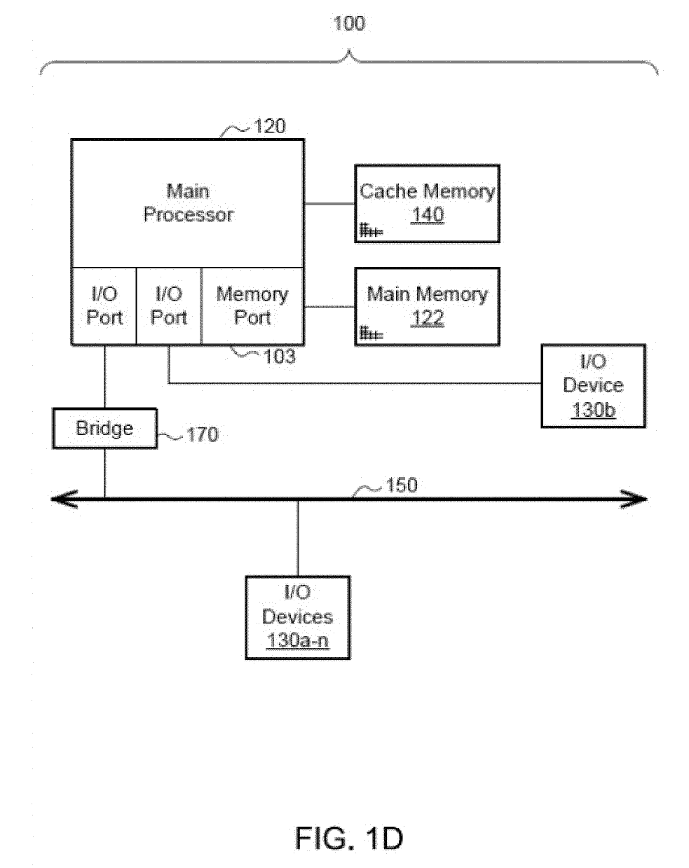

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the illustrated exploring network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106. The clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, NFC, RFID Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network, which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualized physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, and/or software 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via an I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is an eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call. In some embodiments, the communication device 102 is a wearable mobile computing device including but not limited to Google Glass and Samsung Gear.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Systems and Methods for Tracking User Identifiers Across Web Sessions and Websites

Described herein are systems and methods for tracking user identifiers across web sessions and sites. User identifiers (IDs) can be assigned to users and are sometimes referred to as neutral identifiers (NIDs). A user identifier management platform (sometimes referred to as AirDXP platform or NID platform) can include one or more servers. The one or more servers can assign, manage and/or track the NIDs across websites of media partners for example. One or more of the server(s) can include subdomain servers.

A media partner (e.g., comprising one or more websites or web domains) can integrate its website(s) or web domain(s) to the NID platform. A media partner can include a third-party platform, e.g., a website, an advertiser, or an advertising technology platform. Upon integrating with the NID platform, the websites can be securely reinforcing targetability for high-value digital advertisement across browsers, and monetizing it. The integration process can use a canonical name (CNAME) or CNAME record. A CNAME record is a type of Domain Name System (DNS) record that maps one hostname to another hostname. A CNAME record with a subdomain is established under a media partner's website's primary domain. A specific pixel or tag (sometimes referred to as an AirDXP pixel), which can be an image (IMG) tag, is provided and added to the website's pages. To integrate multiple websites, this process can be repeated for each website. The NID platform can use the CNAME record to map a subdomain under a media partner's website's main domain (e.g., nid.yourwebsite.com) to the NID platform (e.g., neutralid.airdxp.com). By implementing this, the NID platform can create and manage the protected first-party cookies the NID platform uses without the media partner having to host new server-side code or add a new external reference to the media partner's tidy HTML templates, for instance.

A system administrator can setup the CNAME for example. The process can include the following. In the media partner's DNS system, create a new CNAME record, which can include the following by way of a non-limiting example: (a) entering “nid” as the subdomain (sometimes also referred to as host or name); (b) entering “neutralid.airdxp.com” as the value (sometimes referred to as “points to”); and (c) enter “86400” or other desired value as the time-to-live (TTL) (e.g., to inform browsers to cache lookups for 24 hours) for instance

Upon confirming that the CNAME as active, the NID management and tracking process can be activated or go-live. By deploying the pixel (e.g., IMG tag) to every page of a given website, each page view can contribute to knowledge base of monitored activity on the NID platform. The IMG tag can be in the form of:

```
  <img src=″https://nid.yourwebsite.com/g.gif″ style=″display:none;″
  width=″0″
height=″0″/>
```

and can be added or tagged to every page on a specified website.

The NID platform can provide a service for third-party platforms, that delivers a deterministic, persistent user identifier across web sessions and sites, e.g., within a single browser context. The mechanism for tracking or managing NIDs can operate in all web browsers and can fully respect consumer privacy standards. The service can be used for integration into private ID Graphs that facilitate internal data activation and remarketing. Some applications of the service include, but is not limited to:
Same-site and cross-site ID Graph reinforcement for browsers with strict third-party cookie policies,
Cross-site ad retargeting,
Same-site and cross-site data management platform (DMP) or data consolidation to a single deterministic ID,
Same-site and cross-site personalization, and
Same-site and cross-site email triggers.

The service can confirm to General Data Protection Regulation (GDPR), by not engaging in the collection of data from web traffic originating in the European Economic Area (EEA), and prohibiting such use of the platform for such collection.

The NID platform supports usage or implementation methods that include: (a) Pixel-based Redirect, and (b) JavaScript.

### Pixel-Based Redirect Method

With the Pixel-based Redirect method, this method can simply rely on an IMG tag. For the Pixel-based Redirect method, in browsers that have strong third-party cookie restriction policies, the returned ID is usable on subsequent page views. The JavaScript method allows the use of the NID immediately.

The Pixel-based Redirect method can fetch a Neutral ID and pass the NID to a media partner's server via a URL parameter in a 302 redirect for instance. This operation can be similar to a standard cookie-sync. To connect same-user sessions in browsers that restrict third-party cookies, the media partner can include the media partner's own internal, first-party (e.g., JavaScript) cookie ID on the desired response URL. The process or steps to implement this method can include, for example:

1. issue or receive a customer ID (CID).

2. decide on the URL where the media partner may want the NID platform to send the Neutral ID to. This URL should or can be https, and can return a “204 No Content” response or a 1×1 gif response for instance.

3. Place a ˜˜nid˜˜ macro in this URL where the media partner may want the NID platform to insert the Neutral ID on response sync from the service.

4. Append this URL to the NID platform's Neutral ID URL.

5. At run-time, insert the below example IMG tag into the DOM:

<img src=″https://neutralid.airdxp.com/d/i?
cid=[YOURAIRDXPCID]&ru=[YOURURL]
″ width=”0” height=”0” style=”display:none;”/>

As a non-limiting example:
1. Use c017 as your AirDXP the media partner's CID.
3. Insert the ˜˜nid˜˜ macro, to produce this URL: https://you.com/sync.gif?userid=˜˜nid˜˜
4. Append that to the NIC platform's URL to yield: https://neutralid.airdxp.com/d/i?cid=c017&ru=https://you.com/sync.gif?userid=˜˜nid˜˜
5. Insert the latter as the image source (SRC) on an IMG tag into the DOM, in this format:

<img src=″https://neutralid.airdxp.com/d/i?
cid=c017&ru=https://you.com/sync.gif?userid=~~nid~~
″ width=”0” height=”0” style=”display:none;”/>

### JavaScript Method

Unlike the redirect method, JavaScript integration can return the Neutral ID to a webpage so that the NID can be used immediately. However, the JavaScript method may not actually save the Neutral ID. The media partner can decide on or manage saving of the NID. The process or steps to implement this method can include, for example:

1. Load the NID platform's javascript (e.g., neutralid.js) into a webpage:

```
<script
  src=http://neutralid.airdxp.com/neutralid.js
  type=”text/javascript”
  async=”true”
></script>
```

2. Make a call to the NID platform service like the following for example:

```
<script>
  var airDXP = window.airDXP ∥ [ ];
  airDXP.push(function(neutralID) {
  // You use the neutralID here
  });
</script>
```

As a non-limiting example: an NID (e.g., NID789) may have been observed on site A, site B, and site C previously. However, on site D, the media partner's ID Graph may observe or detect a new cookie. The media partner can check the NID platform to proceed as appropriate. For example,

```
<script src=”http://neutralid.airdxp.com/neutralid.js” type=”text/javascript”
async=true></script>
<script>
  var airDXP = window.airDXP ∥ [ ];
  if (myIdGraph.isKnownConsumer( ) === false) {
      airDXP.push(function(nid) {
      myIdGraph.lookupByAirdxpNid(nid, function(myId) {
        if (myId != null) {
          // You have this consumer in your ID Graph,
          // so proceed intelligently
          doStuff(myId);
          } else {
          // You do not have this consumer in your ID Graph,
          // so save the nid to a new profile and provide the new
        consumer experience
          myIdGraph.saveNewForNid(myId,function(myNewId) {
            doStuff(myNewId);
          });
        }
      });
    });
  } else {
    doStuff(myIdGraph.getMyId( ))
  }
</script>
```

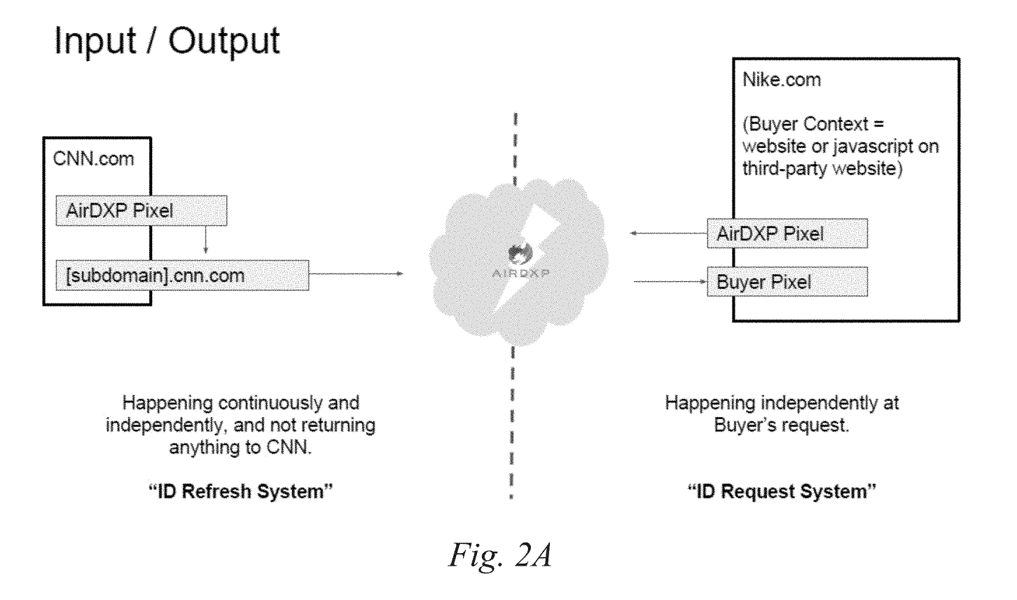

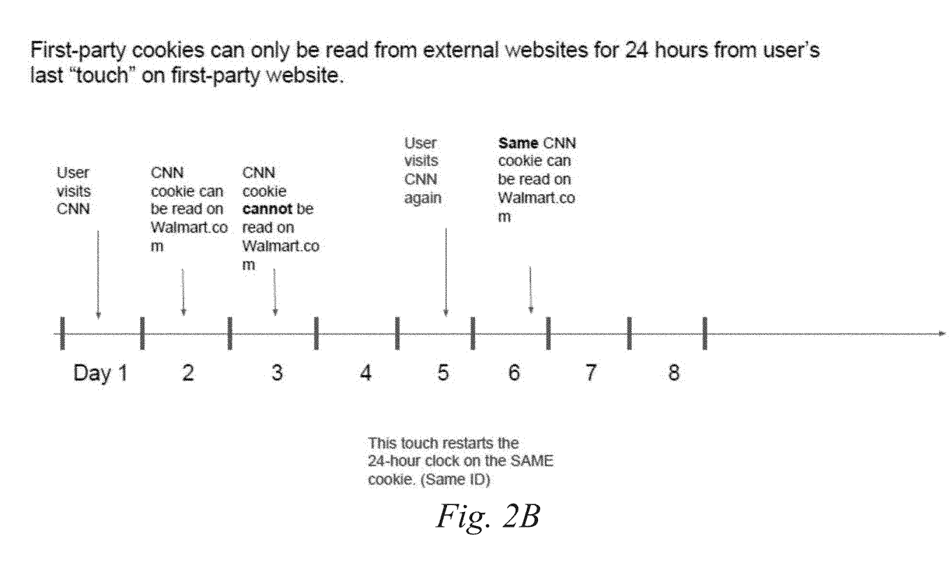

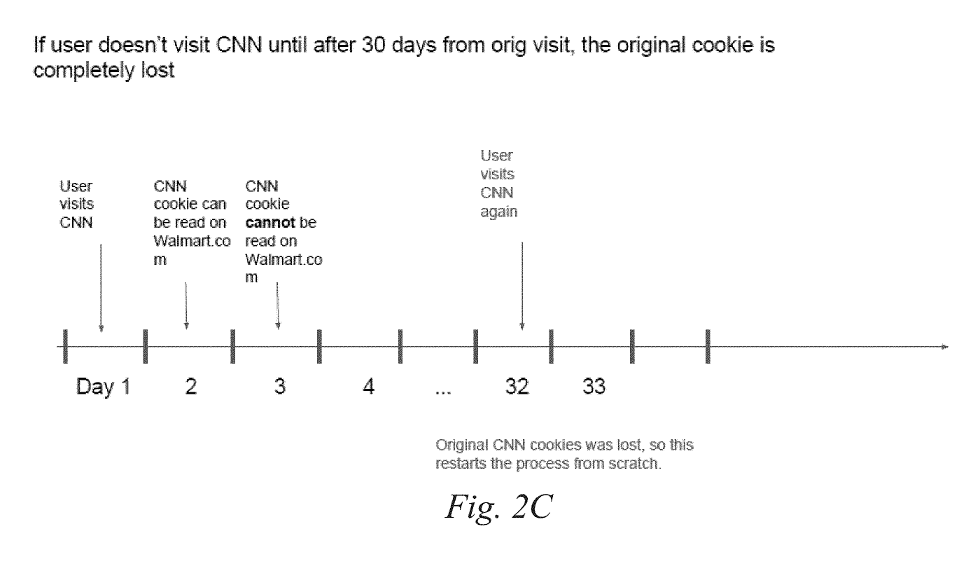

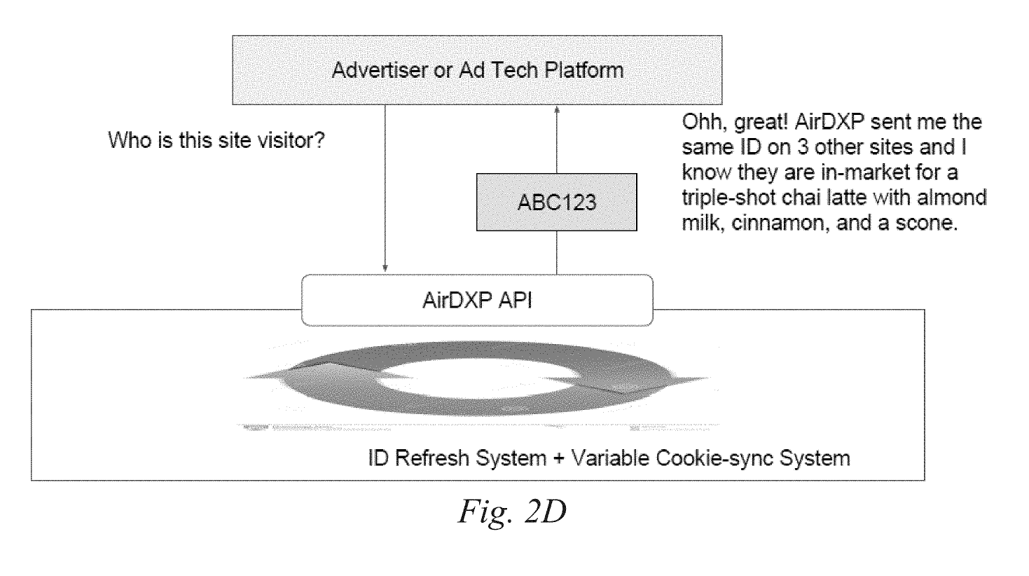

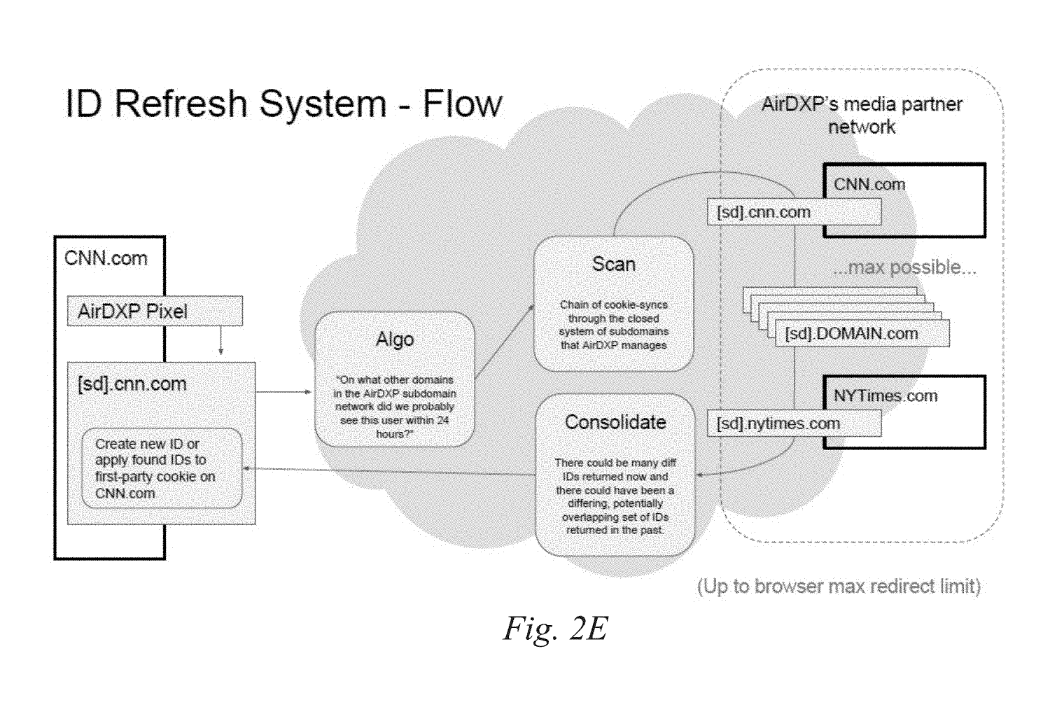

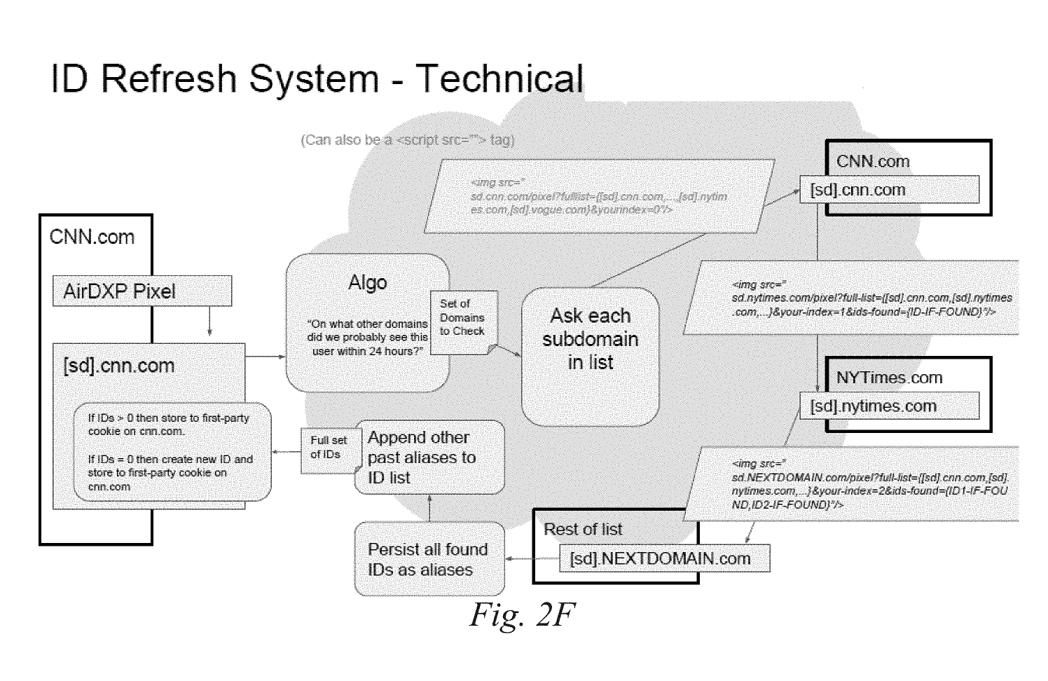

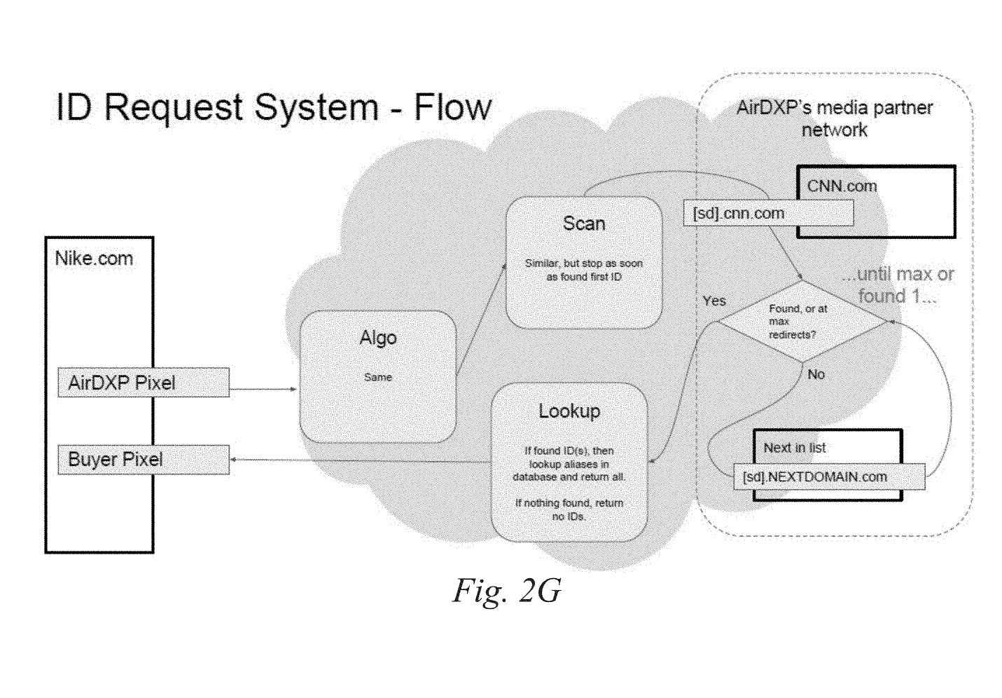

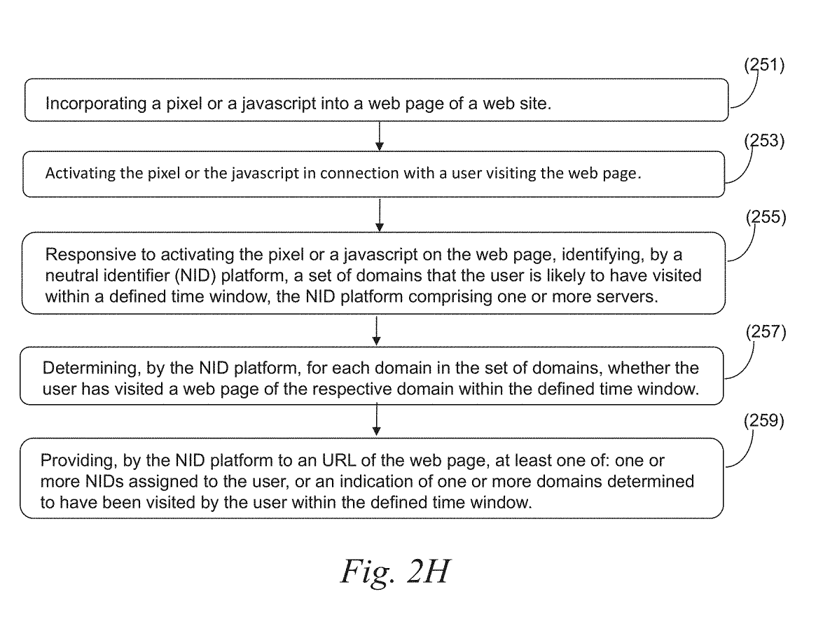

The NID platform can maintain NIDs and keep these NIDs alive, e.g., to maximize tracking potential and data collection. The NID platform can maintain same-user identifiers across cookies and http headers on third-party websites. The NID platform can provide an ID refresh system (e.g., to keep NIDs alive) and an ID request system. As shown in FIG. 2A for example, the service performed by the ID refresh system can occur continuously and independently (e.g., of any media partner or online users), and may not have to return any result to the media partner (e.g., CNN.com). The service performed by the ID request system can occur independently (e.g., of any online users), and can be triggered or requested by the media partner (sometimes referred to as the buyer). A buyer can potentially refer to a buyer of information about an NID or a user, or a buyer of an advertising or impression opportunity to target the user.

FIGS. 2B and 2C show example scenarios in which a cookie (corresponding to or incorporating a user ID or NID) may expire or become unreadable/inaccessible after certain time periods unless the cookie (and the associated user ID or NID) is refreshed or maintained.

FIG. 2D show an example implementation of the NID platform in relation to a media partner. The media partner can be an advertiser (e.g., Latte company, CNN, Nike) or an ad technology platform. The interface with the media partner can be via an application programming interface (API) of the NID platform. The API can receive a query about a site visitor. The NID platform can determine that the site visitor corresponds to a certain NID that has visited multiple sites. The NID platform can provide the media partner with information about the sites visited, and/or online activities of the user corresponding to the NID. The media partner and/or the NID platform can determine, according to the information, that the site visitor may be interested in a certain product or service. The media partner can then target the site visitor with a related advertising or promotion.

FIGS. 2E and 2F depict example embodiments of the ID refresh system. The ID refresh system can apply an algorithm (also referred to as “algo”) to identify or scan for domains that a user (and others) has visited in addition to a media partner's site (that is installed with the AirDXP pixel). The ID refresh system can determine if there are one or more NIDs are assigned to the user, and to assign an NID if not. The ID refresh system can refresh a cookie, e.g., by applying the NID(s) to the cookie. The refresh process can run continuously (e.g., at intermittent or scheduled intervals). Accordingly, the ID refresh system can elongate or extend third-party ID resolution timeframe, e.g., beyond the 24-hour visibility window. The ID refresh system can also enable first-party ID reinstatement beyond the 30-day truncation window.

FIG. 2G depicts an example embodiment of the ID request system. The ID request system can apply an algorithm (also referred to as “algo”) to identify or scan for domains that a user has visited in addition to a media partner's site (that is installed with the AirDXP pixel). The ID request system can determine if there are one or more NIDs are assigned to the user, and to indicate to the media partner (via the media partner's buyer pixel) any NIDs found, and to report none if no NID is found.

The algorithm is sometimes referred as a fingerprinting algorithm. The NID platform can incorporate heuristics and machine learning (e.g., in the algorithm and/or to establish the algorithm) to probabilistically map a current user to a set of most likely recent in-network publisher domains (e.g., web domains or sites of media partners). Heuristics can be identified by a user profile key which is the composite of a set of attributes received in the HTTP request (including headers and any other request info), e.g., of the current user for instance. The set of attributes applied to create a key can determine the level of generality of the profile (e.g., user profile), and thereby the number of end-users likely to have the same key. The NID platform can use many keys. For example, when keys are combined with an IP address (or a segment of the IP address) and/or behavior (e.g. the domains that have been observed before), the NID platform is able to increase the likelihood of figuring out the correct publisher domains (that may be likely relevant to or likely visited by a particular user, from among the in-network publisher domains). Based on the heuristics, the NID platform can derive or determine the set of in-network domains to search for visited domains and/or NID aliases.

In some embodiments, the NID platform is a closed system. The NID platform can provide for no data leakage. For example, subdomain servers are operated by the NID platform, and therefore no media partner can sniff referrer information and slowly build their own intelligence of other web sites' audiences for instance. Thus, the NID platform's heuristics-based and/or variable sync target list process can provide an advancement over existing solutions. Aliases (e.g., NIDs for the same user) are identified and managed carefully by the NID platform to improve business value for the information the NID platform can provide to media partners.

Referring now to FIG. 2H, an example embodiment of a method for tracking user identifiers across websites is depicted. The method can include incorporating a pixel or a javascript into a webpage of a website (251). The method can include activating the pixel or the javascript in connection with a user visiting the webpage (253). The method can include responsive to activating the pixel or a javascript on the webpage, identifying, by a neutral identifier (NID) platform, a set of domains that the user is likely to have visited within a defined time window, the NID platform comprising one or more servers (255). The method can include determining, by the NID platform, for each domain in the set of domains, whether the user has visited a webpage of the respective domain within the defined time window (257). The method can include providing, by the NID platform to an URL of the webpage, at least one of: one or more NIDs assigned to the user, or an indication of one or more domains determined to have been visited by the user within the defined time window (259).

### C. Systems and Methods for Redirecting to Track User Identifiers Across Web Session and Websites

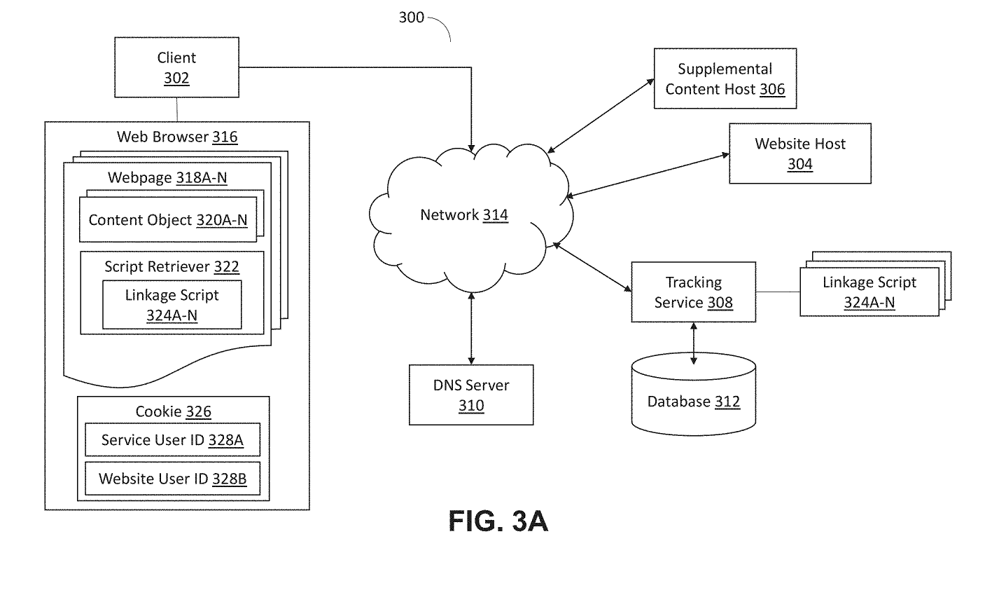

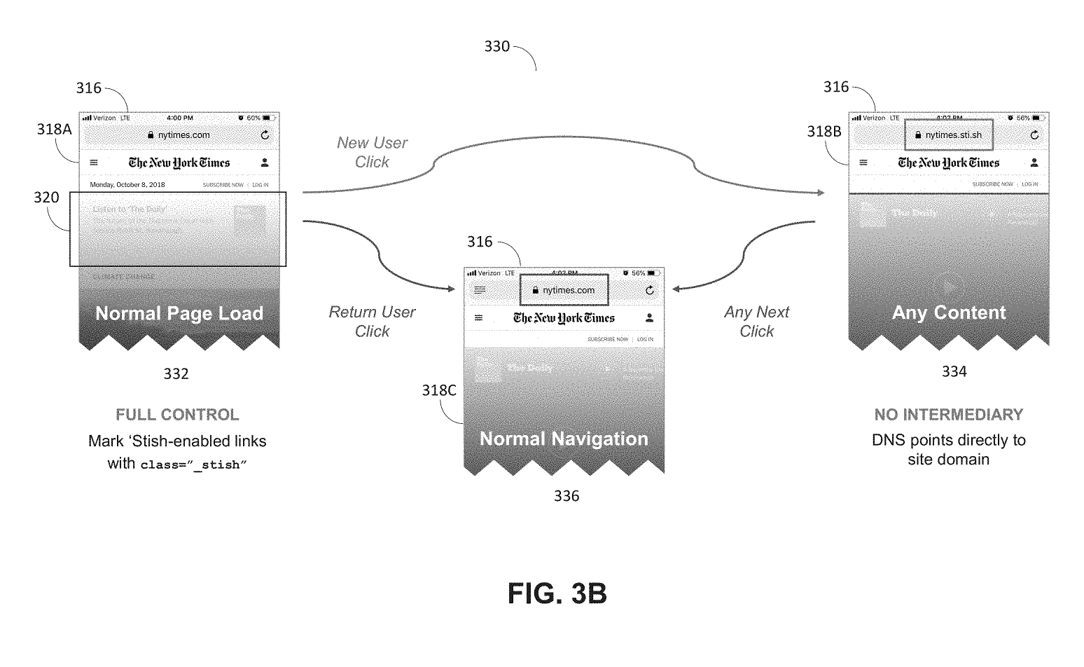

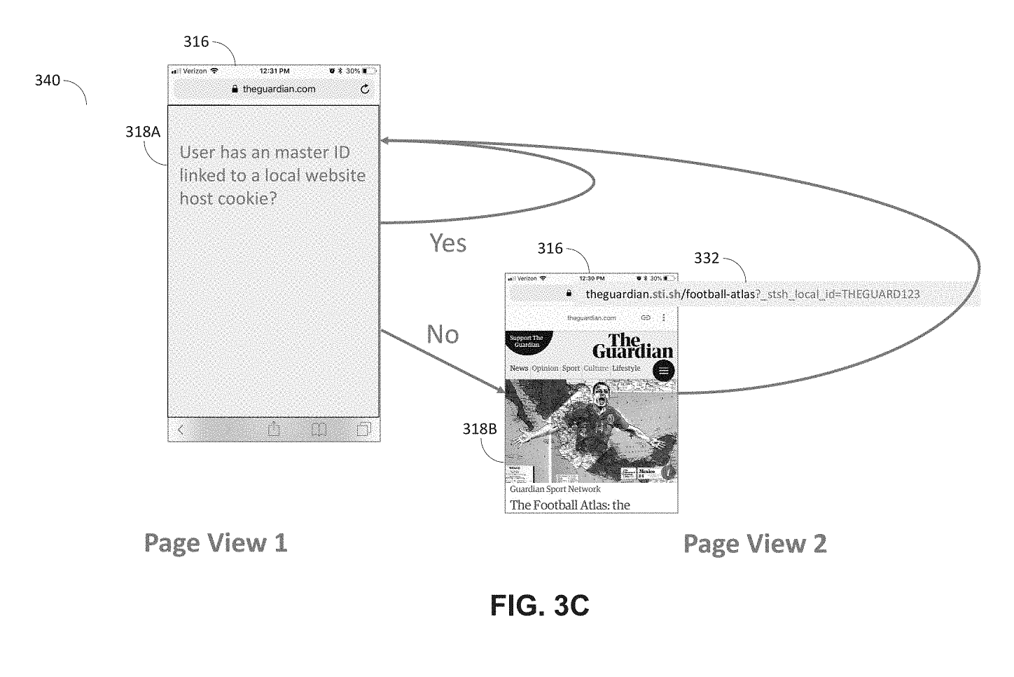

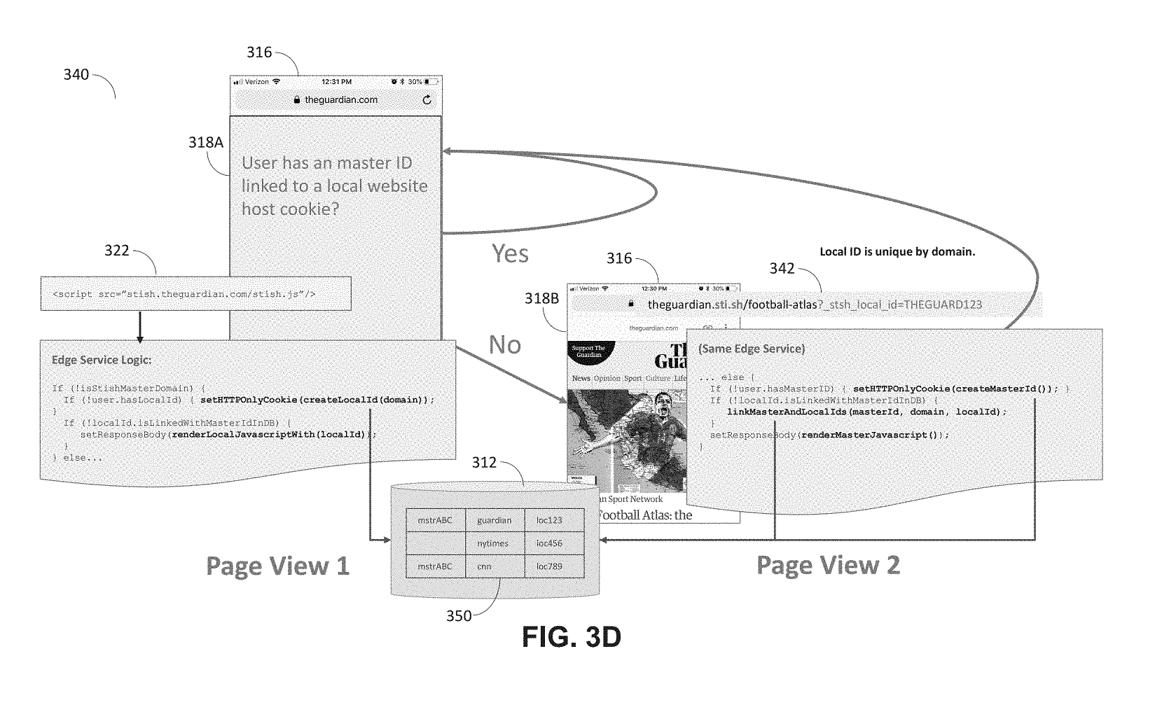

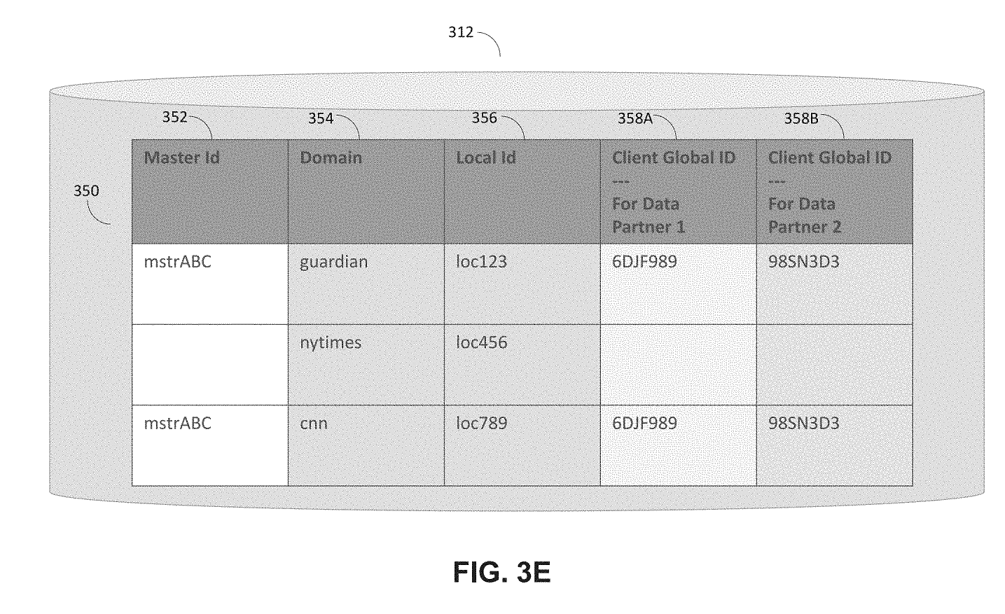

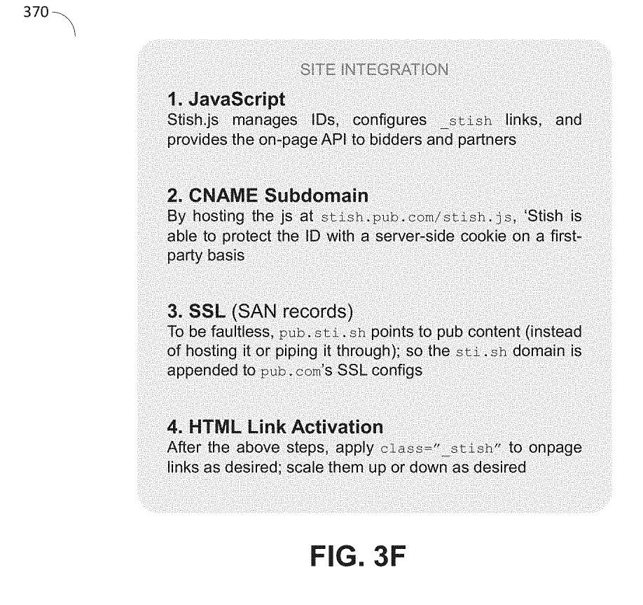

Referring now to FIG. 3A, depicted is a block diagram of a system 300 for redirecting to track user identifiers across web sessions and websites. In brief overview, the system 300 may include at least one client 302, at least one website host 304, at least one supplemental content host 306, at least one tracking service 308, at least one domain name system (DNS) server 310, and at least one database 312, among others. The client 302, the website host 304, the supplemental content host 306, the tracking service 308, the DNS server 310, and the database 312 may be communicatively connected to one another via at least one network 314. The client 302 may include a web browser 316 to access and retrieve content via the network 314. The network 314 may be a public network (e.g., the Internet) or a private network (e.g., Intranet or virtual private network (VPN)), or any combination thereof.

Each of the above-mentioned elements or entities is implemented in hardware, or a combination of hardware and software, in one or more embodiments. Each component of the system 200 may be implemented using hardware or a combination of hardware or software detailed above in connection with FIG. 1. For instance, each of these elements or entities can include any application, program, library, script, task, service, process or any type and form of executable instructions executing on hardware of the client 302 (including the web browser 316), the website host 304, the supplemental content host 306, the tracking service 308, the DNS server 310, and the database 312, among others. The hardware includes circuitry such as one or more processors in one or more embodiments.

In further detail, the web browser 316 executing on the client 302 may send a request for a first webpage 318A from the website host 304. The web browser 316 may be any application to access webpages 318A-N via the network 314 from one or more website hosts 304. The web browser 316 may be, for example, Google Chrome™, Firefox™, Safari™, and Internet Explorer™, among others. In some embodiments, an application other than the web browser 316 may access online resources (e.g., webpages 318A-N) via the network 314. The webpages 318A-N from the same website host 304 may form a website. The first webpage 318A may be the first of the webpages 318A-N requested and accessed by the web browser 316 of the client 302. In some embodiments, the first webpage 318A may be the first of the webpages 318A-N accessed by the web browser 316 without any cookie associated with the website host 304 on the client 302. The request may include an address referencing the first webpage 318A. The address may include a set of alphanumeric characters in accordance with a Uniform Resource Locator (URL). The address for the first webpage 318A may include a protocol (e.g., HTTPS), a hostname, and a pathname, among others. The hostname may include a domain name of the website corresponding to the website host 304. The pathname may include correspond to the first webpage 318A hosted by the website host 304. Once sent by the web browser 316, the request may be forwarded via the network 314 onto the website host 304 referenced in the request.

Subsequently, the website host 304 may receive the request from the client 302 via the network 314. The website host 304 may identify the first webpage 318A referenced by the address included in the request. With the identification, the website host 304 may transmit the first webpage 318A to the web browser 316 on the client 302 via the network 314. The first webpage 318A may include one or more content objects 320A-N (hereinafter generally referred to as content object 320). The first webpage 318A may correspond to a document object model (DOM). The DOM for the first webpage 318A may include one or more elements arranged in a hierarchical manner. Each content object 320 may correspond to one of the elements in the DOM for the first webpage 318A. For example, the content object 320 may be a head element, a body element, a link element, a script element, an inline frame element, an image element, a video element, and an audio element, among others. At least one of the content objects 320 on the first webpage 318A may include a link to another webpage 318A-N of the website host 304. In some embodiments, the content object 320 itself may be a hyperlink to another webpage 318A-N of the website host 304. With the access and retrieval of the first webpage 318A, the web browser 316 may generate a cookie 326 for storage on the client 302 as specified by the first webpage 318A. The cookie 326 may include one or more attributes, such as a domain and a path. By default, the web browser 316 may set the domain of the cookie 326 to the domain name of the website host 304.

In some embodiments, at least one of the content objects 320 may be a content slot to insert content from the supplemental content host 306. The content object 320 may include a script to access content from the supplemental content host 306. The web browser 316 may send a request for supplemental content to the supplemental content host 306. The address may include a set of alphanumeric characters in accordance with a URL. The address may include a protocol (e.g., HTTPS), a hostname, and a pathname, among others. The hostname may include a domain name corresponding to the supplemental content host 306. The domain name of the supplemental content host 360 may differ from the domain name of the website host 304 that provided the first webpage 318A. The pathname may include correspond to the content to be supplied on the webpage 318A by the supplemental content host 306. Once sent by the web browser, the request may be routed via the network 314 to the supplemental content host 306.

In turn, the supplemental content host 306 may receive the request from the client 302 via the network 314. The supplemental content host 306 may identify the content to insert into the content slot of the content object 320. The supplemental content host 306 may then send a response including the content to be inserted into the content slot to the web browser 316. Upon receipt, the web browser 318 may insert the content into the content slot of the corresponding content object 320. With the insertion of the content onto the first webpage 318A, the web browser 316 may block the storage of another cookie in connection with the content from the supplemental content host 306. In some embodiments, the web browser 316 may parse the generated cookie to determine whether the domain of the cookie matches the domain of the first webpage 318A. When the domains do not match, the web browser may restrict the storage of the cookie onto the client 302. Because the web browser 316 blocks cookies with domain names different from the domain names of the first webpage 318A, the supplemental content host 306 may be unable to track the activities of the web browser 316 across various webpages 318A-N and across different website hosts 304.

The first webpage 318A may include a script retriever 322. In some embodiments, at least one of the content objects 320 of the first webpage 318A may include the script retriever 322. In some embodiments, the content object 320 may reference the script retriever 322 via a link to the tracking service 308. The script retriever 322 may be generated and provided by the tracking service 308 to the website host 304. The website host 304 in turn may insert the script retriever 322 into one of the content objects 320 of at least one of the webpages 318A-N (including the first webpage 318A). In some embodiments, the script retriever 322 may be generated and provided by the tracking service 308 to the supplemental content host 306. The supplemental content host 306 may in turn insert the script retriever 322 into content to be inserted into the content slot corresponding to one of the content objects 320 of the webpage 318.

Using the script retriever 322, the web browser 316 may retrieve a linkage script 324A-N (sometimes referred herein as a linkage object or a linkage module) for the first webpage 381A from the website host 304 or the tracking service 308. For example, the linkage script 324A-N may reside on an edge server associated with the website host 304 or the tracking service 308, and the web browser 316 running on the client 302 may retrieved from the edge server. The address to retrieve the linkage script 324A-N may include a top-level domain of the first webpage 318A upon which the linkage script 324A-N is loaded. For example, the domain name of the first webpage 318A may be “www.example.com.” In contrast, the linkage script 324A-N may be, for example, accessed via “<script src=“stish.example.com/stish.js”/>”. In this example, the subdomain for the linkage script 324A-N (e.g., “stish”) may differ from the subdomain of the first webpage 318A (e.g., “www”), but the top-level domains (e.g., “example.com”) may be the same.

In using the script retriever 322, the web browser 316 may send a request for the linkage script 324A-N to incorporate into the first webpage 318A. In some embodiments, the web browser 316 may generate the request to incorporate the linkage script 324A-N based on the address of the first webpage 318A. In some embodiments, the web browser 316 may identify the address of the first webpage 318A. The web browser 316 may determine whether the address of the first webpage 318A (e.g., the domain name) refers to the website host 304 or to the tracking service 308. If the address of the first webpage 318A is determined to refer to the website host 304, the web browser 316 may use an address including a defined string for a subdomain (e.g., “stish”), a top level domain name of the first webpage 318A, and path for the linkage script 324A-N. On the other hand, if the address of the first webpage 318A is determined to refer to the tracking service 308, the web browser 316 may use an address including the full domain of the tracking service 308 and the path for the linkage script 324A-N. The integration of the linkage script 324A-N via the script retriever 322 may be, for example, in accordance with the following pseudocode:

```
<script>
  if (hostnameIsStish( )) {
    injectScriptTagWithSrc(″api.stish.sti.sh/stish.js″) }
  else {
    injectScriptTagWithSrc(″stish.″+ topLevelDomain +″/stish.js″); }
</script>
```

Since the address of the first webpage 318A may refer to the website host 304, the web browser 318 may use the defined string for a subdomain (e.g., “stish”), the top level domain name of the first webpage 318A, and the path for the linkage script 324A-N for the address to integrate the linkage script 324A-N. With the identification of the address, the web browser 316 may send the request to add the linkage script 324A-N. In some embodiments, the web browser 316 may generate the request using an application programming interface (API) specified by the tracking service 308. The request may be directed to the tracking service 308 via the network 314. Upon receipt of the request for the linkage script 324A-NA-N, the tracking service 308 (or a server associated with the tracking service 308) may identify the linkage script 324A-N to provide to the web browser 318 running on the client 302. In some embodiments, the tracking service 308 may select one of a plurality of linkage scripts to provide to the web browser 318 of the client 302 based on the domain name of the first webpage 318A. One linkage script 324A may overwrite, alter, or otherwise modify the links to other webpages 318A-N of the website host 304 to direct requests to the tracking service 308. One linkage script 324B may overwrite, alter, or otherwise modify the links to other webpages 318A-N of the website host 304 to direct requests to the website host 304. Another linkage script 32AC may maintain the links to the other webpages 318A-N of the website host 304. The selection of the linkage script 324A-N by the tracking service 308 may be of the following pseudocode:

```
If (!isStishMasterDomain) {
  If (!user.hasLocalId) {setHTTPOnlyCookie(createLocalId(domain)); }
  If (!localId.isLinkedWithMasterIdInDB) {
    //This local JS will rewrite links that may append localId to query string
    setResponseBody(renderLocalJavascriptWithLinkRewritesUsingLocalId(localId)
      );
  }
  //This local JS will NOT rewrite links
  setResponseBody(renderLocalJavascriptWithNoLinkRewrites( ));
  }
  else {
    If (!user.hasMasterID) { setHTTPOnlyCookie(createMasterId( )); }
    If (!localId.isLinkedWithMasterIdInDB) { linkMasterAndLocalIds(masterId,
      domain, localId); }
    //Master JS always points links back to origin server.
    setResponseBody(renderMasterJavascript( ));
}
```

The tracking service 308 may determine whether the domain name of the address for the first webpage 318A corresponds to the website host 304 or to the tracking service 308. In some embodiments, the tracking service 308 may identify the address for the first webpage 318A. The address for the first webpage 318 may correspond to the URL appearing on an address bar of the tracking service 308. With the identification of the address, the tracking service 308 may parse the address to identify the hostname. The tracking service 308 may determine whether the address of the first webpage 318A is referencing the website host 304 or the tracking service 308. In some embodiments, the tracking service 308 may determine whether the hostname included in the address contains a defined string for the tracking service 308. If the hostname includes the defined string (e.g., as the top-level domain), the tracking service 308 may determine that the address references the tracking service 308. On the other hand, if the hostname does not include the defined string, the tracking service 308 may determine that the address does not reference the tracking service 308. As the first webpage 318A is the first of the webpages 318A-N in the website of the website host 304, the tracking service 308 may determine that the address of the first webpage 318A references the website host 304 and not the tracking service 308. The functionalities of the tracking service 308 and the linkage script 324A-N when the address of a webpage references the tracking service 308 and not the website host 304 will be detailed herein in conjunction with discussion of the second webpage 318B.

When the hostname of the address is determined to reference the website host 304 and not the tracking service 308, the tracking service 308 may determine whether any service user identifier 328A of the tracking service 308 is associated with the cookie 326 of the website host 304. The service user identifier 328A (sometimes referred herein as a master user identifier or master identifier) may include a set of alphanumeric characters used by the tracking service 308 to identify or reference the user of the tracking service 308 across multiple website hosts 304. In determining whether any service user identifier 328A of the tracking service 308 is associated with the cookie 326 of the website host 304, the tracking service 308 may determine the client 302 has a website user identifier 328B for the website host 304. The website user identifier 328B may include a set of alphanumeric characters used by the tracking service 308 to identify or reference the user of the tracking service 308 for a single website host 304 (e.g., the website host 304 for the first webpage 318A). In some embodiments, the tracking service 308 may access a storage of the client 302 to determine whether the client 302 has any website user identifier 328B for the website host 304. When the website user identifier 328B is determined not to be stored on the client 302, the tracking service 308 may generate the website user identifier 328B for the website host 304. In some embodiments, the tracking service 308 may generate the website user identifier 328B based on the domain name for the website host 304 (e.g., using a hash function on “www.example.com”). The tracking service 308 may also determine that no service user identifier 328A is associated with the cookie 326 of the website host 304. With the determination that the service user provider 328A is not associated with the cookie 326, the tracking service 308 may select the linkage script 324A to overwrite the links to other webpages 318A-N of the website host 304 to direct requests to the tracking service 308. The tracking service 308 may then provide the linkage script 324A to the web browser 316 running on the client 302 for insertion into the first webpage 318A.

In some embodiments, the generation of the website user identifier 328B for the website host 304 may be part of in conjunction with a generation of the cookie 326 for the website host 304 to be stored on the tracking service 308 (or a server associated with the tracking service 308). In some embodiments, the tracking service 308 may determine whether the client 302 has stored a cookie 326 for the website host 304. If the client 302 does not have a cookie 326 stored for the website host 304, the tracking service 308 may generate the cookie 326 for storage on the tracking service 308 (or the client 302). The cookie 326 may include one or more attributes, such as a domain and a path. By default, the web browser 316 may set the domain of the cookie 326 to the domain name of the website host 304. In addition, the web browser 316 may set the path of the cookie 326 to the pathname of the first webpage 318A. The tracking service 308 may generate the website user identifier 328B for the website host 304. In some embodiments, the tracking service 308 may generate the cookie 326 as an HTTP-only cookie (e.g., by setting an attribute of the cookie 326 to “HttpOnly”) for storage on the client 302. With the cookie 326 set as the HTTP-only cookie, other scripts running on the client 302 may not be able to access the contents of the cookie 326. Upon generation of the website user identifier 328B, the tracking service 308 may insert the website user identifier 328B into the cookie 326. The tracking service 308 may also determine that no service user identifier 328A is associated with the cookie 326 of the website host 304. With the determination that the service user provider 328A is not associated with the cookie 326, the tracking service 308 may select the linkage script 324A to overwrite the links to other webpages 318A-N of the website host 304 to direct requests to the tracking service 308. The tracking service 308 may then provide the linkage script 324A to the web browser 316 running on the client 302 for insertion into the first webpage 318A.

On the other hand, when the website user identifier 328B is determined to be associated with the client 302, the tracking service 308 may determine whether the stored website user identifier 328B is associated with any service user identifier 328A maintained by the tracking service 308. The tracking service 308 may access the database 312 maintained by the tracking service 308. The accessing of the database 312 may be in accordance with an application programming interface (API) specified by the tracking service 308. The database 312 may store and maintain: domain names of website hosts 304, a set of service user identifiers 326 for each user; a set of website user identifiers 328 (sometimes referred herein as local user identifier or local identifiers) particular to the domain corresponding to the website host 304; and a set of supplemental content user identifiers (sometimes referred herein as global identifiers) particular to supplemental content hosts 306. In the database 312, each domain of the website host 304 may be associated with at least one of the service user identifiers 329A, the website user identifiers 328B, and the supplemental content user identifiers. The tracking service 308 may use the website user identifier 328B and the domain name of the first webpage 318A to search the database 312 for the service user identifier 328A associated with the website user identifier 328B.

The tracking service 308 may access the database 312 to search for the service user identifier 328A associated with the website user identifier 328B for the website host 304. The tracking service 308 may determine that there are no service user identifiers 326 associated with the website user identifier 328B based on the search. In response to the determination, the tracking service 308 may determine that no service user identifier 328A is associated with the cookie 326 of the website host 304 b. With the determination that the service user provider 328A is not associated with the cookie 326, the tracking service 308 may select the linkage script 324A to overwrite the links to other webpages 318A-N of the website host 304 to direct requests to the website host 304. The tracking service 308 may then provide the linkage script 324A to the web browser 316 running on the client 302. On the other hand, the tracking service 308 may determine the service user identifier 328A associated with the web site user identifier 328B based on the search. The tracking service 308 may determine that there is a service user identifier 328A is associated with the cookie 326 of the website host 304. With the determination that the service user provider 328A is associated with the cookie 326, the tracking service 308 may select the linkage script 324C to maintain the links to other webpages 318A-N of the website host 304 to direct requests to the website host 304. The tracking service 308 may then provide the linkage script 324C to the web browser 316 running on the client 302 for insertion into the first webpage 318A.

Upon receipt of the linkage script 324A via the script retriever 322, the web browser 316 may invoke the functionality of the linkage script 324A. When invoking the functionalities of the linkage script 324A, the web browser 316 may identify an address referencing the second webpage 318B in the website of the website host 304. The address may be for retrieving the second webpage 318B of the website host 304. In some embodiments, the web browser 316 may select the address from a set of addresses for retrieving the second webpage 318B. Each address may include a hostname and a pathname for the second webpage 318B. The hostname may differ among the set of addresses, and may include at least a portion of the domain name for the website host 304. The pathname for the second webpage 318B may be the same across the sets of address. The selection of the address for retrieving the second webpage 318B may be based on the determination on whether the service user identifier 328A is associated with the cookie 326 in accordance with the linkage script 326.

In running the linkage script 324A, the web browser 316 may select the address to include a portion of the domain name for the website host 304 and a defined string for the tracking service 308. The defined string may include a set of alphanumeric characters to reference the tracking service 308. In some embodiments, the defined string for the tracking service 308 may correspond to the top-level domain name and the portion of the domain name for the website host 304 may correspond to the remainder of the domain name. For example, the address to retrieve the second webpage 318B may include “www.example.sti.sh” as the domain name. In this example, “www.example” is the portion of the domain name for the website host 304 and the “.sti.sh” may be the top-level domain for the tracking service 308. In some embodiments, the web browser 308 may further include the website user identifier 328B as a query in the address to retrieve the second webpage 318B. For example, the address for the second page 318B may include “www.example.stish/home/ex_pageB.html?user_id=ABC.” In this example, “ABC” is the website user identifier 328B and is included as the query of the address.

Upon receipt of the linkage script 324C via the script retriever 322, the web browser 316 may invoke the functionality of the linkage script 324C. When invoking the functionalities of the linkage script 324C, the web browser 316 may use the address to include the entirety of the domain name for the website host 304. In some embodiments, the web browser 316 may maintain the addresses to the webpages 318A-N for the website host 304 originally in the first webpage 318A in accordance with the linkage script 326C. The address may lack the defined string referencing the tracking service 308 as specified by the linkage script 326C. For example, the address to retrieve the second webpage 318B may include “www.example.com/home/ex_pageB.html.”

With the identification of the address referencing the second webpage 318B, the web browser 316 may send a request for the second webpage 318B. In some embodiments, the web browser 316 may generate the request using the identified address for retrieving the second webpage 318B. In some embodiments, the web browser 316 may generate and send the request for the second webpage 318B using the identified address, in response to detecting an interaction with the content object 320 including the link to the second webpage 318B. The second webpage 318B may be any of the webpages 318A-N requested and accessed by the web browser 316 on the client 302. In some embodiments, the second webpage 318B may be one of the webpages 318A-N requested from the first webpage 318A, when the client 302 has stored the cookie 326 of the website host 304 providing the webpages 318A-N of the website. The request may include the address for the second webpage 318B identified based on the determination of whether the service user identifier 328A associated with the cookie 326 of the website host 304. If the service user identifier 328A is determined to be not associated with the cookie 326 of the website host 304, the address may include a portion of the domain name for the website host 304 and the defined string for the tracking service 308. On the other hand, if the service user identifier 328A is determined to be associated with the cookie 326 of the website host 304, the address may include the entirety of the domain name. The web browser 316 may transmit the request for the second webpage 318B via the network 314.

Upon transmission, the request for the second webpage 318B may be routed or directed through the network 314 to the website host 304 or the tracking service 308 based on the address included in the request. In some embodiments, the DNS server 310 may be configured to route the request based on the address included in the request. The DNS server 310 may be provided with a mapping between the set of addresses and the tracking service 308 and the website host 304. The mapping may be provided by the tracking service 308 via the network 314. The mapping may specify that requests with a hostname of the address that includes a portion of the domain name for the website host 304 and the defined string for the tracking service 308 is to be directed to the tracking service 308. The mapping may specify that requests with a hostname of the address that includes the entirety of the domain name for the website host 3043 is to be directed to the website host 304. Based on the mapping, the DNS server 310 may route the request for the second webpage 318B to the website host 304 or the tracking service 308. In some embodiments, the DNS server 308 may parse the address included in the request for the second webpage 318B to identify the hostname. If the hostname includes a portion of the domain name for the website host 304 and the defined string for the tracking service 308, the DNS server 310 may route the request to the tracking service 308. On the other hand, if the hostname includes the entirety of the domain name for the website host 304, the DNS server 310 may route the request to the website host 304.

Upon receipt of the request, the tracking service 308 may parse the request to identify the address for retrieving the second webpage 318 and to identify the website user identifier 328B from the request. In addition, the tracking service 308 may identify the portion of the domain name for the website host 304 and the defined string for the tracking service 308 from the host name included in the address. In some embodiments, the tracking service 308 may remove the defined string for the tracking service 308 from the hostname included in the address, and may insert the original string (e.g., the top-level domain) to reference the website host 304. In some embodiments, the tracking service 308 may identify the full domain name for the website host 304 based on the portion of the domain name included in the hostname of the address of the request. With the identification of the full domain name, the tracking service 308 may add the website user identifier 328B from the request along with a domain identifier onto the database 312. The domain identifier may be a set of alphanumeric characters to identify the website host 304. The domain identifier may include, for example, the full domain name of the website host 304 or a portion of the domain name of the website host 304, among others. The tracking service 308 may replace the hostname name of the address in the request with the full domain name of the website host 304. The tracking service 308 may then send the request with the replaced hostname to the website host 304 via the network 314.

Conversely, upon receipt of the request from the client 302 or the tracking service 308, the website host 304 may identify the second webpage 318B referenced by the address included in the request. If the request is from the client 302, the website host 304 may transmit the second webpage 318B to the web browser 316 running on the client 302 via the network 314. If the request is from the tracking service 308, the website host 304 may transmit the second webpage 318B to the tracking service 308. The tracking service 308 in turn may send back the second webpage 318B to the web browser 316. In this manner, multiple addresses may be used to refer to the same second webpage 318B. The address bar in the web browser 316 may include the address with the full domain name (e.g., “www.example.com/home/ex_pageB.html”) or the portion of the domain name with the defined string (e.g., “www.example.sti.sh/home/ex_pageB.html”).

The web browser 316 may receive the second webpage 318B via the network 314. The second webpage 318B may include one or more content objects 320A-N (hereinafter generally referred to as content object 320). The second webpage 318B may correspond to a document object model (DOM). The DOM for the second webpage 318B may include one or more elements arranged in a hierarchical manner. Each content object 320 may correspond to one of the elements in the DOM for the second webpage 318B. For example, the content object 320 may be a head element, a body element, a link element, a script element, an inline frame element, an image element, a video element, and an audio element, among others. At least one of the content objects 320 on the second webpage 318B may include a link to another webpage 318A-N of the website host 304. In some embodiments, the content object 320 itself may be a hyperlink to another webpage 318A-N of the website host 304. In some embodiments, with the access and retrieval of the second webpage 318B, the web browser 316 may generate a cookie 326 for storage on the client 302 as specified by the second webpage 318B. The cookie 326 may include one or more attributes, such as a domain and a path. By default, the web browser 316 may set the domain of the cookie 326 to the domain name of the website host 304.

In some embodiments, at least one of the content objects 320 may be a content slot to insert content from the supplemental content host 306. The content object 320 may include a script to access content from the supplemental content host 306. The web browser 316 may send a request for supplemental content to the supplemental content host 306. The address may include a set of alphanumeric characters in accordance with a URL. The address may include a protocol (e.g., HTTPS), a hostname, and a pathname, among others. The hostname may include a domain name corresponding to the supplemental content host 306. The domain name of the supplemental content host 360 may differ from the domain name of the website host 304 that provided the second webpage 318B. The pathname may include correspond to the content to be supplied on the second webpage 318B by the supplemental content host 306. Once sent by the web browser, the request may be routed via the network 314 to the supplemental content host 306.

In turn, the supplemental content host 306 may receive the request from the client 302 via the network 314. The supplemental content host 306 may identify the content to insert into the content slot of the content object 320. The supplemental content host 306 may then send a response including the content to be inserted into the content slot to the web browser 316. Upon receipt, the web browser 318 may insert the content into the content slot of the corresponding content object 320. With the insertion of the content onto the second webpage 318B, the web browser 316 may block the storage of another cookie in connection with the content from the supplemental content host 306. In some embodiments, the web browser 316 may parse the generated cookie to determine whether the domain of the cookie matches the domain of the second webpage 318B. When the domains do not match, the web browser may restrict the storage of the cookie onto the client 302. But since the domain name of the address for the second webpage 318B now references the tracking service 308 instead of the website host 304, the web browser 316 may permit the generation and storage of the cookie 326 onto the client 302. In this manner, the cookies 320 of both the website host 304 as well as the tracking service 308 may be stored on the client 302.

The second webpage 318B may include the script retriever 322. In some embodiments, at least one of the content objects 320 of the second webpage 318B may include the script retriever 322. The content object 320 with the script retriever 322 may be sometimes referred to as a linkage object. In some embodiments, the content object 320 may reference the script retriever 322 via a link to the tracking service 308. The script retriever 322 may be generated and provided by the tracking service 308 to the website host 304. The website host 304 in turn may insert the script retriever 322 into one of the content objects 320 of at least one of the webpages 318A-N (including the second webpage 318B). In some embodiments, the script retriever 322 may be generated and provided by the tracking service 308 to the supplemental content host 306. The supplemental content host 306 may in turn insert the script retriever 322 into content to be inserted into the content slot corresponding to one of the content objects 320 of the webpage 318.

Using the script retriever 322, the web browser 316 may retrieve the linkage script 324A-N for the second webpage 318B from the website host 304 or the tracking service 308. The address to retrieve the linkage script 324A-N may include a top-level domain of the second webpage 318B upon which the linkage script 324A-N is loaded. In some embodiments, the web browser 316 may integrate, insert, or add the linkage script 324A-N based on the address of the second webpage 318B. In some embodiments, the web browser 316 may identify the address of the second webpage 318B. The web browser 316 may determine whether the address of the second webpage 318B (e.g., the domain name) refers to the website host 304 or to the tracking service 308. If the address of the second webpage 318B is determined to refer to the website host 304, the web browser 316 may use an address including a defined string for a subdomain, a top level domain name of the second webpage 318B, and path for the linkage script 324A-N. On the other hand, if the address of the second webpage 318B is determined to refer to the tracking service 308, the web browser 316 may use an address including the full domain of the tracking service 308 and the path for the linkage script 324A-N. As the address of the second webpage 318B may refer to the tracking service 308, the web browser 318 may use the full domain name of the tracking service 308 along with the path for the linkage script 324A-N for the address to integrate the linkage script 324A-N. With the identification of the address, the web browser 316 may send the request to add the linkage script 324A-N. In some embodiments, the web browser 316 may generate the request using an application programming interface (API) specified by the tracking service 308. The request may be directed to the tracking service 308 via the network 314.

Upon receipt of the request for the linkage script 324A-NA-N, the tracking service 308 (or a server associated with the tracking service 308) may identify the linkage script 324A-N to provide to the web browser 318 running on the client 302. In some embodiments, the tracking service 308 may select one of a plurality of linkage scripts to provide to the web browser 318 of the client 302 based on the domain name of the second webpage 318B. The linkage script 324A-N may specify retrieval of the third webpage 318C of the website for the website host 304. The third webpage 318C may refer to any one of the webpages 318A-N of the website host 304 requested and accessed after the second webpage 318B.

The tracking service 308 may determine whether the domain name of the address for the second webpage 318B corresponds to the tracking service 308. tracking service 308 In some embodiments, the tracking service 308 may identify the address for the second webpage 318B. The address for the first webpage 318 may correspond to the URL appearing on an address bar of the tracking service 308. With the identification of the address, the tracking service 308 may parse the address to identify the hostname. The tracking service 308 may determine whether the address of the second webpage 318B is referencing the website host 304 or the tracking service 308. In some embodiments, the tracking service 308 may determine whether the hostname included in the address contains a defined string for the tracking service 308. If the hostname includes the defined string (e.g., as the top-level domain), the tracking service 308 may determine that the address references the tracking service 308. On the other hand, if the hostname does not include the defined string, the tracking service 308 may determine that the address does not reference the tracking service 308. As the second webpage 318B is the second of the webpages 318A-N in the website of the website host 304, the tracking service 308 may determine that the address of the second webpage 318B references the tracking service 308 and not the website host 304. The functionalities of the tracking service 308 and the linkage script 324A-N when the address of a webpage 318A-N references the website host 304 are detailed herein above in conjunction with discussion of the first webpage 318A.

When the hostname of the address is determined to reference the tracking service 308 and not the website host 304, the tracking service 308 may determine whether the client 302 has stored a service user identifier 326. As discussed above, the service user identifier 328A may include a set of alphanumeric characters used by the tracking service 308 to identify or reference the user of the tracking service 308 across multiple website hosts 304. In some embodiments, the tracking service 308 may access a storage of the client 302 to determine whether the client 302 has any service user identifier 326. When the website user identifier 328B is determined not to be stored on the client 302, the tracking service 308 may generate the service user identifier 326. In some embodiments, the tracking service 308 may generate the service user identifier 328A.

In some embodiments, the generation of the service user identifier 328A may be part of in conjunction with a generation of the cookie 326 for the website host 304 to be stored on the client 302. The tracking service 308 may generate the cookie 326 for storage on the client 302 as specified by the second webpage 318B. In some embodiments, the cookie 326 may differ from the cookie 326 generated in conjunction with the first webpage 318A. In some embodiments, the tracking service 308 generate a new cookie 326 different from the cookie 326 generated in conjunction with the cookie 326. The cookie 326 may include one or more attributes, such as a domain and a path. By default, the web browser 316 may set the domain of the cookie 326 to the domain name of the website host 304. In addition, the web browser 316 tracking service 308 may set the path of the cookie 326 to the pathname of the second webpage 318B. The tracking service 308 may generate the service user identifier 328A for the website host 304. In some embodiments, the tracking service 308 may generate the cookie 326 as an HTTP-only cookie (e.g., by setting an attribute of the cookie 326 to “HttpOnly”) for storage on the client 302. The tracking service 308 may wait for a response from the website host 304 or the tracking service 308 before setting the cookie 326 as the HTTP-only cookie. With the cookie 326 set as the HTTP-only cookie, other scripts running on the client 302 may not be able to access the contents of the cookie 326. Upon generation of the service user identifier 326, the tracking service 308 may insert the service user identifier 328A into the cookie 326.

In addition, the tracking service 308 may determine whether the service user identifier 328A is associated with the website user identifier 328B. The determination may be responsive to the generation of the service user identifier 326. In some embodiments, the tracking service 308 may determine whether the service user identifier 328A is associated with the cookie for the website user identifier 328B. In some embodiments, the tracking service 308 may identify the website user identifier 328B stored on the client 302. To determine, the tracking service 308 may access the database 312 maintained by the tracking service 308. The tracking service 308 may use the service user identifier 328A and the domain name of the second webpage 318B to search the database to determine whether the service user identifier 328A is associated with the website user identifier 328B. The tracking service 308 may access the database 312 to search for the service user identifier 328A associated with the website user identifier 328B for the website host 304. In some embodiments, the tracking service 308 may search the database 312 using the service user identifier 326, website user identifier 328B, and the domain name for the second webpage 318B included in the query. Based on the search, the tracking service 308 may determine that the service user identifier 328A is associated with the website user identifier 328B. On the other hand, based on the search, the tracking service 308 may determine that the service user identifier 328A is not associated with the website user identifier 328B. In some embodiments, in response to the determination that the identifiers are not associated, the tracking service 308 may associate the website user identifier 328B with the service user identifier 326. The tracking service 308 may store the domain name for the second webpage 318B along with the association between the website user identifier 328B and the service user identifier 326. With the determination that the service user identifier 328A is associated with the cookie 326, the tracking service 308 may select the linkage script 324B to overwrite the links to other webpages 318A-N of the website host 304 to direct requests to the website host 304. In this manner, subsequent requests for the webpages 318A-N after the first webpage 318A and the second webpage 318B while the association between the service user identifier provider 328A and website user identifier 328B is maintained may reference the website host 304 and not the tracking service 308. The tracking service 308 may then provide the linkage script 324C to the web browser 316 running on the client 302.

Upon receipt of the linkage script 324B via the script retriever 322, the web browser 316 may invoke the functionality of the linkage script 324B. When invoking the functionalities of the linkage script 324B, the web browser 316 may identify an address referencing the third webpage 318C. The address may be for retrieving the third webpage 318C of the website host 304. In some embodiments, the web browser 316 may select the address from a set of addresses for retrieving the third webpage 318C. Each address may include a hostname and a pathname for the third webpage 318C. The hostname may differ among the set of addresses, and may include at least a portion of the domain name for the website host 304. The pathname for the third webpage 318C may be the same across the sets of address. The web browser 316 may select the address to include the entirety of the domain name for the website host 304 to retrieve the third webpage 318C. The address may lack the defined string referencing the tracking service 308. For example, the address to retrieve the second webpage 318C may include “www.example.com/home/ex_pageC.html.” With the identification of the address referencing the third webpage 318C, the web browser 316 may send a request for the third webpage 318C. In some embodiments, the web browser 316 may generate the request using the identified address for retrieving the third webpage 318C. In some embodiments, the web browser 316 may generate and send the request for the third webpage 318C using the identified address, in response to detecting an interaction with the content object 320 with the link to the third webpage 318C. The third webpage 318C may be any of the webpages 318A-N requested and accessed by the web browser 316 on the client 302 after the second webpage 318B. The third webpage 318C may be the same as the first webpage 318A or may differ from the first webpage 318A. The request may include the address for the third webpage 318C. The web browser 316 may transmit the request for the third webpage 318C via the network 314. Upon transmission, the request for the third webpage 318C may be routed through the network 314 to the website host 304.

Subsequently, the website host 304 may receive the request from the client 302 via the network 314. The website host 304 may identify the third webpage 318C referenced by the address included in the request. With the identification, the website host 304 may transmit the third webpage 318C to the web browser 316 on the client 302 via the network 314. The third webpage 318C may include one or more content objects 320A-N (hereinafter generally referred to as content object 320) and the script retriever 322. The third webpage 318C may correspond to a document object model (DOM). The DOM for the third webpage 318C may include one or more elements arranged in a hierarchical manner. Each content object 320 may correspond to one of the elements in the DOM for the third webpage 318C. For example, the content object 320 may be a head element, a body element, a link element, a script element, an inline frame element, an image element, a video element, and an audio element, among others.

While the association between the service user identifier 328A and the website user identifier 328B is maintained, any subsequent requests for webpages 318A-N of the website host 304 may include an address with the full domain name. Furthermore, the same functionalities (e.g., of the script retriever 322, linkage script 324A-N, and tracking service 308) described above may be repeated over multiple website hosts 304. In this manner, the tracking service 308 may circumvent the configuration of web browsers 316 against cross-site cookies. As a result, the tracking service 308 may keep associations of the same user across multiple websites and website hosts 304 and may track activities of the web browser 316 across different websites.

Referring now to FIG. 3B, depicted is sequence diagram depicting a process 330 for redirecting to track user identifiers across web sessions and websites. The process 330 may be performed, executed, or implemented using any one or more of the components described above in conjunction with FIGS. 1A-1D or the system 300 described above in conjunction with FIG. 3A. As depicted, the web browser 316 may have loaded the first webpage 318A (332). The first webpage 318A may be provided by the website host 304, and may include a content object 320 configured with the linkage script 324A-N. The link to the second webpage 318B included in the linkage script 324A-N may be dependent on whether the user is visiting the website for the first time. If the user is visiting the website for the first time, upon clicking on the content object 320, the web browser 316 may be directed to the second webpage 318B with an address referencing the tracking service 308 (334). The second webpage 318B may be referenced by an address that includes a portion of the domain name of the website host 304 and a top-level domain referencing the tracking service 308. The second webpage 318B may also include a content object 320 configured with the linkage object 324. On the other hand, if the user is not visiting the website for the first time, upon clicking on the content object 320, the web browser 316 may be directed to the second webpage 318B with another address referencing the website host 304 (336). The second webpage 318B may be referenced by an address that includes a full domain name of the website host 304.

Referring now to FIGS. 3C and 3D, depicted is a sequence diagram depicting a process 340 for redirecting to track user identifiers across web sessions and websites. The process 340 may be performed, executed, or implemented using any one or more of the components described above in conjunction with FIGS. 1A-1D or the system 300 described above in conjunction with FIG. 3A. Upon interaction with the content object 320 configured with the linkage script 324A-N on the first webpage 318A, the web browser 316 may determine whether the service user identifier 328 is associated with the cookie 326 for the website host 304 on the client 302. The cookie 326 may include or may be associated with the website user identifier 326 for the website host 304. If there is s service user identifier 328 associated with the cookie 326, the web browser 316 may use the full domain name of the website host 304 in requesting subsequent webpages 318A-N from the website host 304.

On the other hand, if there is no service user identifier 328 associated with the cookie 326, the web browser 316 may request a second webpage 318B with an address 342 referencing the tracking service 308. The address 342 for the second webpage 318B may include a portion of the domain name for the website host 304 and a set string for the tracking service 308. While on the second webpage 318B, if an interaction on the content object 320 configured with the linkage script 324A-N is detected, the web browser 316 may generate the service user identifier 328. The generation of the service user identifier 328 may be in conjunction with creation of a cookie 326. In addition, the web browser 316 may associate the service user identifier 328 with the website user identifier 326 for storage onto a table 350 on the database 312 maintained by the tracking service 308. In some embodiments, the table 350 may be another data structure, such as an array, a matrix, a linked list, a binary tree, and a heap, among others.

Referring now to FIG. 3E, depicted is a block diagram of the database 312 for maintaining user identifiers tracked across web sessions and websites. The table 350 of the database 312 may include: at least one column 352 for indexing service user identifiers 328, at least one column 354 for indexing domain names of website hosts 304, at least one column 356 for indexing website host identifiers 326 for each website host 304, and one or more columns 358A and 358B for storing supplemental content user identifiers. The service user identifier 328 of the column 352 may be used to track activities of the corresponding user across multiple websites of different website hosts 304. The domain name of the column 354 may reference the corresponding website host 304. The website user identifier 326 of the column 356 may be specific to the website host 304, and may differ across different website hosts 304. The supplemental content user identifiers on columns 358A and 358B may be specific to a data partner (e.g., content selection platforms or advertisers) for a particular user. The tracking service 308 may maintain the table 350 stored on the database 312. The tracking service 308 may use the columns 352 and 354 of the table 350 to determine whether a give service user identifier 328 is linked to or associated with a website user identifier 326.

Referring now to FIG. 3F, depicted is a list diagram depicting a process 370 for site integration into webpages for redirecting. The process 370 may be performed, executed, or implemented using any one or more of the components described above in conjunction with FIGS. 1A-1D or the system 300 described above in conjunction with FIG. 3A. In accordance with the process 370, first, a script (e.g., the linkage script 324A-N) may manage user identifiers (e.g., service user identifiers 326 and website user identifiers 328) and may configure the links used to request another webpage 318A-N of the website host 304. Second, the linkage script 324A-N may be hosted on another domain (e.g., the domain name corresponding to the tracking service 308). In this manner, the tracking service 308 may protect the user identifiers with a server-side cookie or a cookie accessible from the server. Third, the addresses for accessing webpages through the linkage script 324A-N may reference to webpages themselves. The top-level domain of the tracking service 308 may be appended to the hostname in requests for webpages of the website host 304. Fourth, the linkage script 324A-N may be activated or invoked via a hyperlink (e.g., a user interaction on the hyperlink).

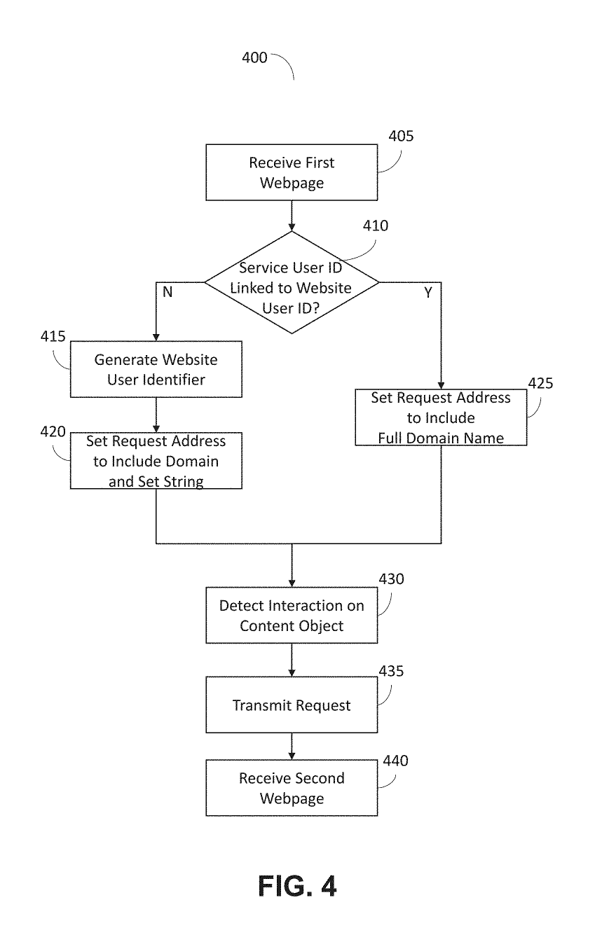

Referring now to FIG. 4, depicted is a flow diagram of a method 400 of redirecting to track user identifiers across web sessions and websites. The method 400 may be performed, executed, or implemented using any one or more of the components described above in conjunction with FIGS. 1A-1D or the system 300 described above in conjunction with FIGS. 3A-3F. In brief overview, a web browser may receive a first webpage (405). The web browser may determine whether a service user identifier is linked to a website user identifier (410). If the service user identifier is linked to the website user identifier, the web browser may set a request address to include the full domain name (415). Otherwise, if the service user identifier is not linked to the website user identifier, the web browser may generate the website user identifier (420). The web browser may set a request address to include a portion of the domain name and a set string (425). The web browser may detect an interaction on a content object (430). The web browser may transmit the request (435). The web browser may receive a second webpage (440).

In further detail, the web browser (e.g., the web browser 316) may receive a first webpage (e.g., the first webpage 318A) (405). The first webpage may include a content object (e.g., the content object 320) with a linkage script or a linkage object. The linkage object may reference a script on tracking service (e.g., the tracking service 308). The first webpage may be from a website host, and may be the first on the website visited by the user of the web browser. The first webpage may be referenced by an address with a hostname containing the full domain name of the website host.

Whether a service user identifier (e.g., the service user identifier 328A) is linked to a website user identifier (e.g., the website user identifier 328B) may be determined (410). In determining whether the server user identifier is linked to the website user identifier, the tracking service may determine whether the client has stored any website user identifier. If there is no website user identifier, the tracking service may determine that the service user identifier is not linked to any website user identifier for the user. In contrast, if there is a website user identifier, the tracking service may access a database (e.g., the database 312) maintained by the tracking service to determine whether the service user identifier is linked with the website user identifier.

If the service user identifier is linked to the website user identifier, the web browser may set a request address to include the full domain name (415). The request address may reference a second webpage (e.g., the second webpage 318B) with the full domain name. Otherwise, if the service user identifier is not linked to the website user identifier, the web browser may generate the website user identifier (420). The generation of the website user identifier may be based on the domain name of the website host. The web browser may set a request address to include a portion of the domain name and a set string (425). The set string may correspond to a top-level domain referencing the tracking service. The web browser may detect an interaction on a content object (e.g., the content object 320 with link to the second webpage 318B) (430). Upon generation of the request, the web browser may transmit the request (435). The request may be routed to the website host of the first webpage or the tracking service, depending on the address included in the webpage. The webpage referenced in the request may be retrieved by the website host or the tracking host, and be provided to the client. The web browser may receive the second webpage (440).

The description herein including modules emphasizes the structural independence of the aspects of the system components, and illustrates one or more grouping of operations and responsibilities. Other groupings that execute similar overall operations are understood within the scope of the present application. Modules may be implemented in hardware and/or as computer instructions on a non-transient computer readable storage medium, and modules may be distributed across various hardware or computer based components.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

Example and non-limiting module implementation elements include sensors providing any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), and/or digital control elements.

Non-limiting examples of various embodiments are disclosed herein. Features from one embodiments disclosed herein may be combined with features of another embodiment disclosed herein as someone of ordinary skill in the art would understand.

As utilized herein, the terms “approximately,” “about,” “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described without restricting the scope of these features to the precise numerical ranges provided. Accordingly, these terms should be interpreted as indicating that insubstantial or inconsequential modifications or alterations of the subject matter described and are considered to be within the scope of the disclosure.

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure. It is recognized that features of the disclosed embodiments can be incorporated into other disclosed embodiments.

It is important to note that the constructions and arrangements of apparatuses or the components thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

While various inventive embodiments have been described and illustrated herein, those of ordinary skill in the art will readily envision a variety of other mechanisms and/or structures for performing the function and/or obtaining the results and/or one or more of the advantages described herein, and each of such variations and/or modifications is deemed to be within the scope of the inventive embodiments described herein. More generally, those skilled in the art will readily appreciate that, unless otherwise noted, any parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way unless otherwise specifically noted. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

What is claimed is:

1. A method of redirecting to track user identifiers across web sessions and websites, comprising:
receiving, by a web browser executing on a client having one or more processors from a website host via a network, a first webpage requested by a user of the client, the first webpage referenced by a first address including a domain name corresponding to the website host, the first webpage including a linkage script and a content object to link to a second webpage of the website host, the linkage script provided by a tracking service and specifying retrieval of the second webpage;
determining whether a user identifier of the tracking service is associated with a cookie of the website host;
identifying, by the web browser, a second address referencing the second webpage as specified by the linkage script based on determining whether the user identifier of the tracking service is associated with the cookie of the website host, the second address including at least a portion of the domain name of the website host;
transmitting, by the web browser via the network responsive to an interaction with the content object, a request for the second webpage of the website host, the request including the second address referencing the second webpage; and
receiving, by the web browser via the network, the second webpage referenced by the second address for display on the client.

2. The method of claim 1, wherein determining whether the user identifier is associated with the cookie further comprises determining that the user identifier is associated with the cookie; and
wherein identifying the second address further comprises selecting the second address including an entirety of the domain name of the website host in accordance with the content object to direct the request to the website host, responsive to determining that the user identifier is associated with the cookie.

3. The method of claim 1, wherein determining whether the user identifier is associated with the cookie further comprises determining that the user identifier is not associated with the cookie; and further comprising:
generating, by the web browser, the user identifier for the user based on the domain name responsive to determining that the user identifier is not associated with the cookie;
wherein identifying the second address further comprises selecting the second address including a portion of the domain name of the website host and a defined string for the tracking service to direct the request to the tracking service in accordance with the linkage script; and
wherein transmitting the request further comprises transmitting the request for the second webpage, the request including the user identifier to store the user identifier for the user on the tracking service.

4. The method of claim 1, wherein determining whether the user identifier is associated with the cookie further comprises determining that the user identifier is not associated with the cookie; and further comprising:
generating, by the web browser, the user identifier for the user based on the domain name responsive to determining that the user identifier is not associated with the cookie; and
wherein identifying the second address further comprises selecting the second address including a hostname and a query, the hostname of the second address including a portion of the domain name of the website host and a defined string for the tracking service to direct the request to the tracking service, the query including the user identifier.

5. The method of claim 1, wherein determining whether the user identifier is associated with the cookie further comprises accessing a database storing a plurality of user identifiers maintained by the tracking service to determine whether the user identifier corresponds to any of the plurality of user identifiers.

6. The method of claim 1, wherein transmitting the request further comprises transmitting the request via the network to a domain name system (DNS) server, the DNS server configured to route the request to the tracking service responsive to determining that the second address included in the request includes the portion of the domain name of the website host and a defined string for the tracking service.

7. The method of claim 1, wherein receiving the first webpage further comprises receiving the first webpage including the content object, the content object corresponding to a hyperlink to the second webpage of the website host, the hyperlink to be modified in accordance with the linkage script.

8. The method of claim 1, wherein receiving the second webpage further comprises receiving the second webpage referenced by the second address including a portion of the domain name of the web site host and a defined string for the tracking service, the second webpage including a second linkage script; and further comprising:
determining, by the web browser, whether the user identifier is associated with the cookie; and
generating, by the web browser, the identifier for the user responsive to determining that the user identifier is not associated with the cookie in accordance with the second linkage script.

9. The method of claim 1, wherein receiving the second webpage further comprises receiving the second webpage referenced by the second address including a portion of the domain name of the web site host and a defined string for the tracking service, the second webpage including a second linkage script; and further comprising:
determining, by the web browser whether the user identifier is not linked with a master user identifier maintained by the tracking service for the user; and
associating, by the web browser, the user identifier with the master identifier responsive to determining that the user identifier is not linked with the master user identifier.

10. The method of claim 1, wherein receiving the second webpage further comprises receiving the second webpage referenced by the second address including a portion of the domain name of the web site host and a defined string for the tracking service, the second webpage including a second linkage script and a second content object, the second content object having a third address referencing a third webpage of the website host; and further comprising:
identifying, by the web browser, the third address referencing the third webpage as specified by the second linkage script responsive to determining that the user identifier is linked with a master user identifier, the third address including the domain name of the website host and lacking any defined string for the tracking service;
transmitting, by the web browser via the network, a request for the third webpage of the website host, the request including the third address referencing the second webpage; and
receiving, by the web browser via the network, the third webpage referenced by the third address for display on the client.

11. A system for redirecting to track user identifiers across web sessions and websites, comprising:
a web browser executable on a client having one or more processors, configured to:
receive, from a website host via a network, a first webpage requested by a user of the client, the first webpage referenced by a first address including a domain name corresponding to the website host, the first webpage including a linkage script and a content object to link to a second webpage of the website host, the linkage script provided by a tracking service and specifying retrieval of the second webpage;
identify a second address referencing the second webpage as specified by the linkage object based on determining whether the user identifier of the tracking service is associated with the cookie of the website host, the second address including at least a portion of the domain name of the website host;
transmit, via the network responsive to an interaction with the content object, a request for the second webpage of the website host, the request including the second address referencing the second webpage; and
receive, via the network, the second webpage referenced by the second address for display on the client.

12. The system of claim 11, wherein the web browser is further configured to:
determine that the user identifier is associated with the cookie; and
select the second address including an entirety of the domain name of the website host in accordance with the linkage script to direct the request to the web site host, responsive to determining that the user identifier is associated with the cookie.

13. The system of claim 11, wherein the web browser is further configured to:
generate the user identifier for the user based on the domain name responsive to determining that the user identifier is not associated with the cookie;
select the second address including a portion of the domain name of the website host and a defined string for the tracking service to direct the request to the tracking service in accordance with the linkage script; and
transmit the request for the second webpage, the request including the user identifier to store the user identifier for the user.

14. The system of claim 11, wherein the web browser is further configured to:
generate the user identifier for the user based on the domain name responsive to determining that the user identifier is not associated with the cookie; and
select the second address including a hostname and a query, the hostname of the second address including a portion of the domain name of the website host and a defined string for the tracking service to direct the request to the tracking service, the query including the user identifier.

15. The system of claim 11, wherein the tracking service is further configured to access a database storing a plurality of user identifiers maintained by the tracking service to determine whether the user identifier corresponds to any of the plurality of user identifiers.

16. The system of claim 11, wherein the web browser is further configured to transmit the request via the network to a domain name system (DNS) server, the DNS server configured to route the request to the tracking service responsive to determining that the second address included in the request includes the portion of the domain name of the website host and a defined string for the tracking service.

17. The system of claim 11, wherein the content object corresponds to a hyperlink to the second webpage of the website host, the hyperlink to be modified in accordance with the linkage script.

18. The system of claim 11, wherein the web browser is further configured to:
receive the second webpage referenced by the second address including a portion of the domain name of the website host and a defined string for the tracking service, the second webpage including a second linkage script;
generate the identifier for the user responsive to determining that the user identifier is not associated with the cookie in accordance with the second linkage script.

19. The system of claim 11, wherein the web browser is further configured to:
receive the second webpage referenced by the second address including a portion of the domain name of the website host and a defined string for the tracking service, the second webpage including a second linkage script;
associate the user identifier with the master identifier responsive to responsive to determining that the user identifier is not linked with the master user identifier.

20. The system of claim 11, wherein the web browser is further configured to:
receive the second webpage referenced by the second address including a portion of the domain name of the website host and a defined string for the tracking service, the second webpage including a second linkage script and a second content object, the second content object having a third address referencing a third webpage of the web site host;
identify the third address referencing the third webpage as specified by the second linkage script responsive to determining that the user identifier is linked with a master user identifier, the third address including the domain name of the web site host and lacking any defined string for the tracking service;
transmit, via the network, a request for the third webpage of the website host, the request including the third address referencing the second webpage; and
receive, via the network, the third webpage referenced by the third address for display on the client.
